(19) United States
(12) Patent Application Publication
(10) Pub. No.: US 2018/0227318 A1
(43) Pub. Date: Aug. 9, 2018

(54) INFORMATION PROCESSING APPARATUS AND INFORMATION PROCESSING SYSTEM

(71) Applicant: FUJITSU LIMITED, Kawasaki-shi (JP)

(72) Inventors: Yustinus Juli, Yokohama (JP); KAZUYA KONNO, Yokohama (JP); Toshinori Wakako, Kawasaki (JP); Tomohiro Ozawa, Yokohama (JP)

(73) Assignee: FUJITSU LIMITED, Kawasaki-shi (JP)

(21) Appl. No.: 15/874,990

(22) Filed: Jan. 19, 2018

(30) Foreign Application Priority Data
Feb. 9, 2017 (JP) 2017-022145

(51) Int. Cl. H04L 29/06; H04L 12/24; H04L 12/931

(52) U.S. Cl. CPC H04L 63/1416; H04L 49/354; H04L 41/0627; H04L 63/1441

(57) ABSTRACT

An information processing apparatus of the present disclosure is connected to be able to communicate with a switching device connected to a first network and a second network to which a plurality of computers are connected. The information processing apparatus includes a memory and a processor coupled with the memory. The processor receives a notification of a security risk detected in one of the plurality of computers. When the notification is received, the processor instructs the switching device to switch one of a connection destination network of the computer in which the security risk is to detected and a connection destination network of a computer in which the security risk is not detected, to the first network and switch the other network to the second network.

### CROSS-REFERENCE TO RELATED APPLICATION

This application is based upon and claims the benefit of priority of the prior Japanese Patent Application No. 2017-022145, filed on Feb. 9, 2017, the entire contents of which are incorporated herein by reference.

### FIELD

The embodiments discussed herein are related to an information processing apparatus, a computer-readable recording medium, and an information processing system.

### BACKGROUND

A plurality of computers are connected to each other through a network to be used as a business system. In this business system, there is also a business system using a detection system for detecting a security problem of the computers on the network. In the detection system, for example, when a computer infected with a computer virus is detected, the corresponding computer is isolated from the business system so that the influence of the computer virus on the business system is reduced.

Related technologies are disclosed in, for example, “Latest Version of Comprehensive Server Security Countermeasure Product ‘Trend Micro Deep Security 9.5’” (Online), Trend Micro Corp., Oct. 30, 2014 (searched on Jan. 10, 2017), Internet <URL:http://www.trendmicro.co.jp/jp/about-us/press-eleases/articles/20141027012409.html> (Non-Patent Document 1), and “Cyber Attack Automatic Defense Solution” (Online), NEC Corp., (searched on Jan. 10, 2017), Internet <URL:http://jpn.nec.com/sdn/sol08.html> (Non-Patent Document 2).

### SUMMARY

According to an aspect of the embodiments, an information processing apparatus of the present disclosure is connected to be able to communicate with a switching device connected to a first network and a second network to which a plurality of computers are connected. The information processing apparatus includes a memory and a processor coupled with the memory. The processor receives a notification of a security risk detected in one of the plurality of computers. When the notification is received, the processor instructs the switching device to switch one of a connection destination network of the computer in which the security risk is detected and a connection destination network of a computer in which the security risk is not detected, to the first network and switch the other network to the second network.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of an inspection system in a case where a business server is a physical server;

FIG. 2 is a view illustrating an example of an inspection system in a case where a business server is a virtual server;

FIG. 3 is a diagram illustrating an example of a hardware configuration of an information processing apparatus;

FIG. 4 is a diagram illustrating an example of process blocks of a switching management server;

FIG. 5 is a view illustrating an example of a management table of a virtual environment management server;

FIG. 6 is a view illustrating an example of a management table of an antivirus software management server;

FIG. 7 is a view illustrating an example of a physical switch management table;

FIG. 8 is a view illustrating an example of a logical server management table;

FIG. 9 is a view illustrating an example of a management table of a logical server network;

FIG. 10 is a view illustrating an example of a management table of a logical server network switching;

FIG. 11 is a view illustrating an example of an action customization management table;

FIG. 12 is a view illustrating an example of a notified content storage table;

FIG. 13 is a view illustrating an example of an occurring event storage table;

FIG. 14 is a view Illustrating an example of a management table of a mail transfer server;

FIG. 15 is a view illustrating an example of a virtual environment management table;

FIG. 16 is a view illustrating an example of a virtual server management table;

FIG. 17 is a view Illustrating an example of a physical server management table;

FIG. 18 is a view Illustrating an example of a management table of physical switch port information;

FIG. 19 is a view Illustrating an example of a management table of virtual switch port information;

FIG. 20 is a view illustrating an example of a mail content management table;

FIG. 21 is a view illustrating an example of a definition table of an antivirus software management server;

FIG. 22 is a view illustrating a first example of “Message Format” of a definition table;

FIG. 23 is a view Illustrating a second example of “Message Format” of a definition table;

FIG. 24 is a view illustrating a third example of “Message Format” of a definition table;

FIG. 25 is a view illustrating an example of information notified by an SNMP trap;

FIG. 26 is a view illustrating an example of a packet of an SNMP trap;

FIG. 27 is a view illustrating an example of security risk notification to be stored in the occurring event storage table by a control process in response to reception of an SNMP trap;

FIG. 28 is an example of a view illustrating an outline of a network switching process in a case where a business server is a physical server;

FIG. 29 is an example of a view Illustrating an outline of a network switching process in a case where a business server is a virtual server;

FIG. 30 is an example of a view Illustrating an outline of a notification process to a manager and a user at the time of computer virus infection in a case where a business server is a physical server;

FIG. 31 is an example of a view illustrating an outline of a notification process to a user at the time of inspection completion in a case where a business server is a physical server;

FIG. 32 is an example of a view illustrating an outline of a notification process to a manager and a user at the time of computer virus Infection in a case where a business server is a virtual server;

FIG. 33 is an example of a view illustrating an outline of a notification process to a user at the time of inspection completion in a case where a business server is a virtual server;

FIG. 34 is a view illustrating an example of processes in the inspection system according to the first embodiment;

FIG. 35 is a view Illustrating an example of a notification process to a manager and a user when a logical server is infected with a computer virus;

FIG. 36 is a view Illustrating an example of processes after inspection of a computer virus in the inspection system according to the first embodiment;

FIG. 37 is a view illustrating an example of a notification process to a user after completion of inspection of a logical server;

FIG. 38 is a view illustrating an example of a process of analyzing a notification received by a switching server; and

FIG. 39 is a view illustrating an example of a work flow from a construction to an operation of an inspection system which is performed by a manager.

### DESCRIPTION OF EMBODIMENTS

A manager of the business system performs an inspection work inducing, for example, investigation of a computer infected with a computer virus and disinfection of the computer virus. For example, the inspection work is performed by connecting the computer infected with a computer virus to a network different from the business system. Since the inspection work is performed by a network different from the business system, the influence of the Inspection work on the business system is suppressed.

However, it is burdensome for the manager to prepare a network different from the business system and connect the computer infected with the computer virus to the prepared network for the inspection work of the corresponding computer.

Hereinafter, an inspection system according to embodiments will be described with reference to the accompanying drawings. The configuration of each embodiment described below is an example, and the present disclosure is not limited to the configurations of the embodiments.

### First Embodiment

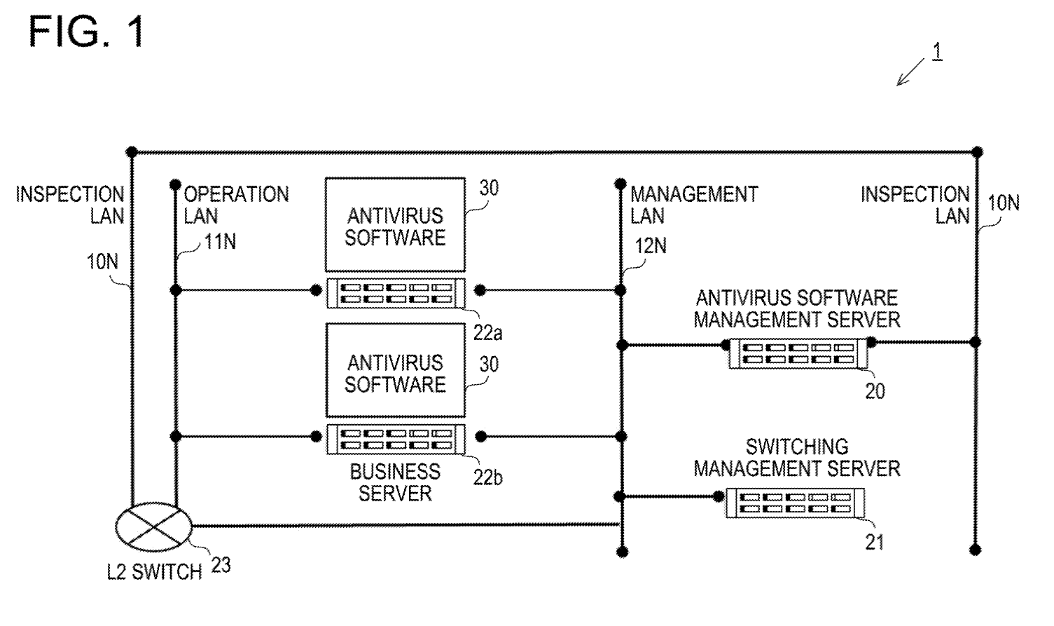

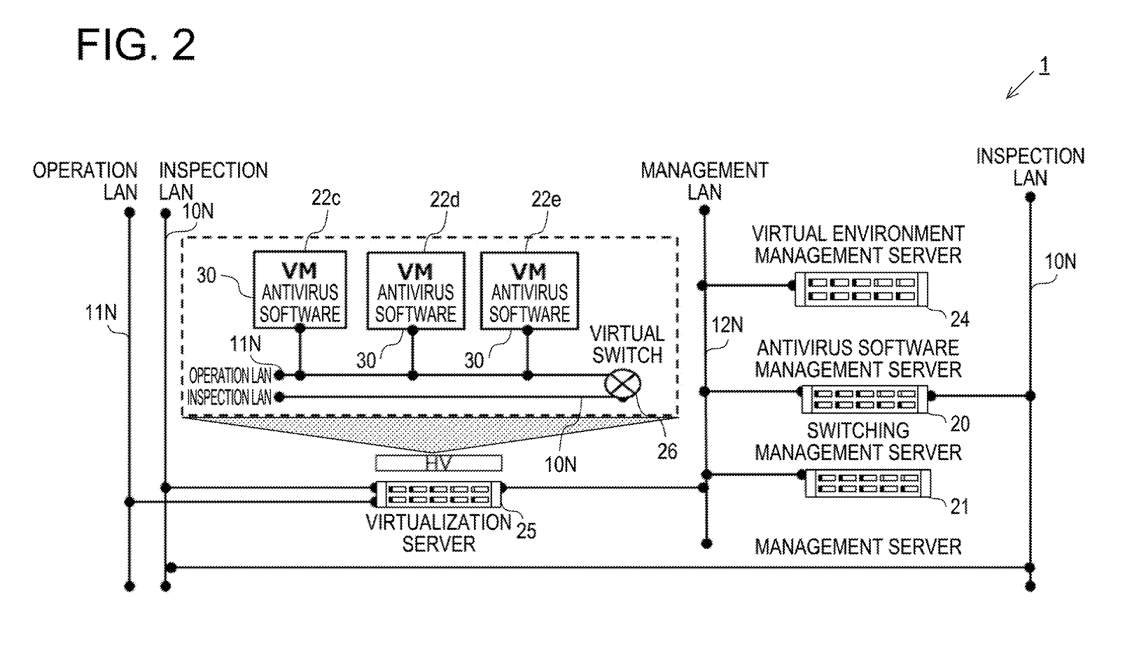

In a first embodiment, descriptions will be made on an example of an inspection system in which a connection of a virus-infected business server is switched to an inspection local area network (LAN). The business server may be a physical server or a virtual server. FIGS. 1 and 2 are diagrams illustrating an example of an inspection system 1 according to the first embodiment. Hereinafter, the inspection system 1 according to the first embodiment will be described with reference to the drawings. The inspection system 1 is an example of an “information processing system.”

FIG. 1 is a diagram illustrating an example of the inspection system 1 in a case where a business server 22 is a physical server. The inspection system 1 includes a plurality of business servers 22 (22a and 22b), an antivirus software management server 20, a switching management server 21, a layer-2 switch (L2 switch) 23, an operation LAN 11N, an inspection LAN 10N, and a management LAN 12N.

The business server 22 is an information processing apparatus. The business server 22 provides a user with various services via the operation LAN 11N. The business server 22 is connected to the operation LAN 11N and the management LAN 12N. An antivirus software 30 is Installed in the business server 22. When a known computer virus is detected on the business server 22, the antivirus software 30 may perform a disinfection of the corresponding computer virus. Further, for example, when a computer virus is detected on the business server 22 or the business server 22 is infected with a computer virus, the antivirus software 30 notifies the antivirus software management server 20 of an occurrence of the computer virus or the like via the management LAN 12N. The business server 22 is an example of a “computer.”

The antivirus software management server 20 is an information processing apparatus that manages the antivirus software 30 installed in the business server 22. The antivirus software management server 20 is connected to the management LAN 12N and the inspection LAN 10N. The antivirus software management server 20 receives the notification from the antivirus software 30 operating on the business server 22, via the management LAN 12N. Upon receiving the notification, the antivirus software management server 20 notifies the switching management server 21 of the received notification via the management LAN 12N. The antivirus software management server 20 is an example of a “server that copes with a security risk in a computer.” The process by the antivirus software management server 20 to make the notification to the switching management server 21 is an example of a process by a “transfer unit.”

The switching management server 21 is an information processing apparatus that switches a connection destination network of the business server 22 between the operation LAN 11N and the inspection LAN 10N. For example, the switching is performed by making an instruction to a virtual switch 26 via the L2 switch 23 illustrated in FIG. 1 or a virtual environment management server 24 illustrated in FIG. 2. The switching management server 21 is an example of an “information processing apparatus.” The switching management server 21 is also an example of a “second computer.”

The L2 switch 23 is a network switch capable of setting a virtual LAN (VLAN). The L2 switch 23 is connected to the operation LAN 11N, the inspection LAN 10N, and the management LAN 12N. By setting a VLAN, the L2 switch 23 causes a communication with the operation LAN 11N, the inspection LAN 10N, and the management LAN 12N to be impossible. The L2 switch 23 is capable of changing the setting of the VLAN based on an Instruction from the switch management server 21. By changing the setting of the VLAN, for example, the L2 switch 23 causes one business server 22 to be connected to the operational LAN 11N, and another business server 22 to be connected to the inspection LAN 10N. The L2 switch 23 is an example of a “switching device.” The setting of a VLAN by the L2 switch 23 is an example of a “switching unit.”

Each of the operation LAN 11N, the management LAN 12N, and the inspection LAN 10N is a network that connects a plurality of information processing apparatuses to be able to communicate with each other. The operation LAN 11N is, for example, a LAN used for a normal business. Various services provided by the business server 22 are usable via the operation LAN 11N. The management LAN 12N is, for example, a network used for controls of the inspection system 1 such as notification of computer virus detection and Instruction for VLAN switching. The inspection LAN 10N is, for example, a network for executing a work of eliminating a computer virus from the business server 22 infected with a computer virus. The inspection LAN 10N is an example of a “first network.” The operation LAN 11N is an example of a “second network.”

FIG. 2 is a diagram illustrating an example of the inspection system 1 in a case where the business server 22 is a virtual server. Components similar to those in FIG. 1 will be denoted by the same reference numerals as used in FIG. 1, and descriptions thereof will be omitted. The configuration of the inspection system 1 in a case where the business server 22 is a virtual server will be described with reference to FIG. 2.

The virtual environment management server 24 is an information processing apparatus that manages a virtualization server 25, the business server 22 which operates on the virtualization server 25, and the virtual switch 26. The virtual environment management server 24 changes a setting of the virtual switch 26 according to, for example, an instruction from the switching management server 21. By changing the setting of the virtual switch 26, the connection destination network of each of the business servers 22c, 22d, and 22e may be changed. The virtual environment management server 24 is an example of a “switching device.”

The virtualization server 25 is an information processing apparatus provided with a hypervisor (HV). The virtualization server 25 is connected to the management LAN 12N, the operation LAN 11N, and the inspection LAN 10N. The hypervisor provided in the virtualization server 25 is software for creating a virtual server, changing a setting of the created virtual server and others. The business servers 22c, 22d, and 22e and the virtual switch 26 operate on the hypervisor. The virtualization server 25 is also called a VM host.

The business servers 22c, 22d, and 22e are virtual servers. Each virtual server is virtually created as an independent information processing apparatus by, for example, combining resources including a CPU and a memory equipped in the virtualization server 25 with each other. The business servers 22c, 22d, and 22e are connected to the operation LAN 11N in the virtualization server 25. Each virtual server is also called a VM guest.

The virtual switch 26 is a network switch operating on the hypervisor. The virtual switch 26 is connected to the operation LAN 11N and the inspection LAN 10N in the virtualization server 25. The business servers 22c, 22d, and 22e which are virtual servers are connected to the operation LAN 11N and the inspection LAN 10N by a virtual network. According to an instruction from the virtual environment management server 24, the virtual switch 26 is capable of connecting one of the business servers 22c, 22d, and 22e to the operation LAN 11N in the virtualization server 25, and connecting another business server 22 to the inspection LAN 10N. The virtual switch 26 is an example of a “switching device.”

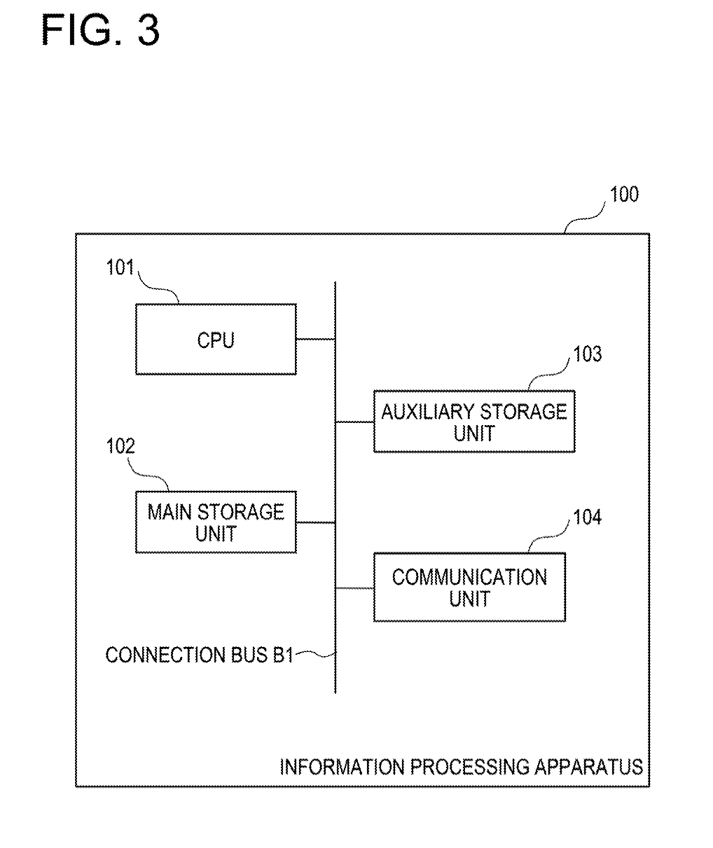

FIG. 3 is a diagram illustrating an example of a hardware configuration of an information processing apparatus 100. The information processing apparatus 100 includes a central processing unit (CPU) 101, a main storage unit 102, an auxiliary storage unit 103, a communication unit 104, and a connection bus B1. The CPU 101, the main storage unit 102, the auxiliary storage unit 103, and the communication unit 104 are connected to each other by the connection bus B1. The information processing apparatus 100 may be used as each of the antivirus software management server 20, the switching management server 21, the virtual environment management server 24, the virtualization server 25, and the business servers 22a and 22b.

The CPU 101 is also called a microprocessor (MPU). The CPU 101 is not limited to a single processor but may have a multiprocessor configuration. In addition, a single CPU 101 connected by a single socket may have a multicore configuration. In the information processing apparatus 100, the CPU 101 develops programs stored in the auxiliary storage unit 103, in a work area of the main storage unit 102 and controls peripheral apparatuses by executing the programs. Thus, the information processing apparatus 100 is capable of executing processes meeting a predetermined goal. The main storage unit 102 and the auxiliary storage unit 103 are storage media readable by the information processing apparatus 100.

The main storage unit 102 is an example of a storage unit directly accessed from the CPU 101. The main storage unit 102 includes a random access memory (RAM) and a read only memory (ROM).

The auxiliary storage unit 103 stores various programs and data in a storage medium to be freely readable and writable. The auxiliary storage unit 103 is also called an external storage device. The auxiliary storage unit 103 stores an operating system (OS), various programs, various tables and others. The OS includes a communication interface program for exchanging data with an external device or the like connected via the communication unit 104. The external device or the like includes, for example, another information processing apparatus and an external storage device which are connected by a computer network or the like. In addition, the auxiliary storage unit 103 may be, for example, a part of a cloud system which is a computer group on a network.

The auxiliary storage unit 103 is, for example, an erasable programmable ROM (EPROM), a solid state drive (SSD), a hard disk drive (HDD) or the like. In addition, the auxiliary storage unit 103 is, for example, a compact disc (CD) drive device, a digital versatile disc (DVD) drive device, a Blu-ray (registered trademark) disc (BD) drive device or the like. In addition, the auxiliary storage unit 103 may be provided by a network attached storage (NAS) or a storage area network (SAN).

The storage medium readable by the information processing apparatus 100 indicates a storage medium in which information such as data or programs is accumulated by an electrical, magnetic, optical, mechanical, or chemical action, and is readable by the information processing apparatus 100. Among the storage media, a storage media removable from the Information processing apparatus 100 is, for example, a flexible disk, a magneto-optical disk, a CD-ROM, a CD-R/W, a DVD, a Blu-ray disk, DAT, an 8 mm tape, a memory card or the like. In addition, a storage medium fixed to the information processing apparatus 100 is, for example, a hard disk, an SSD, a ROM or the like.

The communication unit 104 is, for example, an interface with computer networks such as the operation LAN 11N, the inspection LAN 10N, and the management LAN 12N. The communication unit 104 communicates with an external device via a computer network. The communication unit 104 is also called a network interface card (NIC).

The information processing apparatus 100 may further include an Input unit that receives, for example, an operation Instruction from a user or the like. The input unit may be, for example, an input device such as a keyboard, a pointing device, a touch panel, an acceleration sensor, or a voice input device.

The Information processing apparatus 100 may include an output unit that outputs, for example, data processed by the CPU 101 or data stored in the main storage unit 102. The output unit may be, for example, an output device such as a cathode ray tube (CRT) display, a liquid crystal display (LCD), a plasma display panel (PDP), an electroluminescence (EL) panel, an organic EL panel, or a printer.

<Process Blocks of Switching Management Server 21>

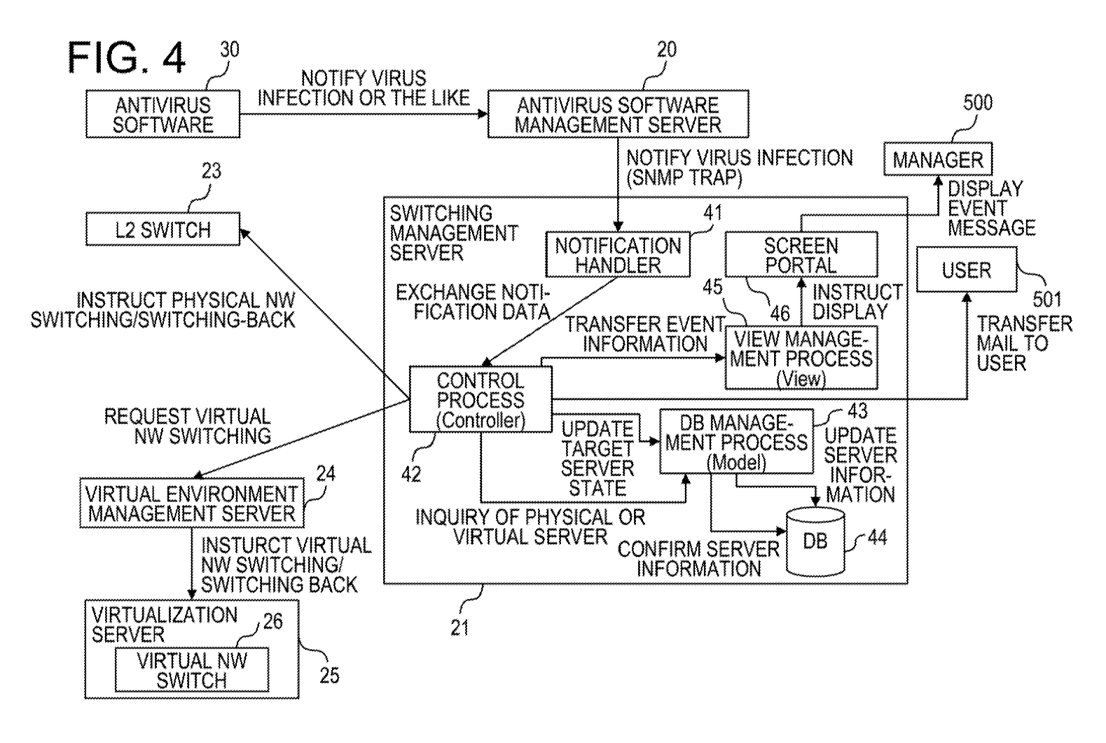

FIG. 4 is a diagram illustrating an example of process blocks of the switching management service 21. The switching management server 21 includes a notification handler 41, a control process 42, a database (DB) management process 43, a view management process 45, a screen portal 46, and a database 44. The information processing apparatus 100 executes processes as each of the units of the switching management server 21 such as the notification handler 41, the control process 42, the DB management process 43, the view management process 45, the screen portal 46, the database 44 and others, when the CPU 101 executes the computer programs developed in an executable manner in the main storage unit 102. Further, FIG. 4 illustrates the antivirus software 30 operating on the business server 22, the antivirus software management server 20, the L2 switch 23, the virtual environment management server 24, the virtualization server 25, and the virtual switch 26, as examples of the components related to the switching management server 21. Further, FIG. 4 illustrates a manager 500 of the inspection system 1 and a user 501 of the business server 22.

At least part of the processes of the respective units may be executed by processors other than the CPU 101 such as, for example, dedicated processors such as a digital signal processor (DSP), a graphics processing unit (GPU), an arithmetic operation processor, a vector processor, an image processing processor and others. In addition, at least part of the processes of the respective units may be an integrated circuit (IC) or other digital circuits. In addition, at least part of the respective units may include analog circuits. The integrated circuit includes an LSI, an application specific integrated circuit (ASIC), and a programmable logic device (PLD). The PLD includes, for example, a field-programmable gate array (FPGA). Each of the respective units may be a combination of a processor and an integrated circuit. The combination is called, for example, a microcontroller, a system-on-a-chip (SoC), a system LSI, a chip set or the like.

As described above, when the business server 22 is infected with a computer virus, the antivirus software 30 operating on the business server 22 makes a notification to the antivirus software management server 20. Upon receiving the notification from the antivirus software 30, the antivirus software management server 20 makes a notification to the switching management server 21. The notification from the antivirus software management server 20 to the switching management server 21 is performed by, for example, a simple network management protocol (SNMP) trap.

The notification handler 41 receives the notification from the antivirus software management server 20 and passes the notification to the control process 42. The notification handler 41 is an example of a “reception unit.”

The control process 42 receives the notification from the notification handler 41. The control process 42 analyzes, for example, whether the received notification is a notification from the antivirus software management server 20 and what kind of a security risk the notified contents relate to. The security risk is, for example, a computer virus infection. The control process 42 also determines whether the business server 22 which is the notification source is a physical server or a virtual server, by comparing the analysis result and the database 44 with each other. Further, the control process 42 determines an action which is a countermeasure against the notified security risk, by comparing the analysis result and the database 44 with each other. For example, when the business server 22 which is the notification source is a physical server, and the action is a network switching, the control process 42 instructs the L2 switch 23 to switch a network. In addition, for example, when the business server 22 which is the notification source is a virtual server, and the action is a network switching, the control process 42 instructs the virtual environment management server 24 to switch a network. Upon receiving the instruction, the virtual environment management server 24 executes the network switching by switching the setting of the virtual switch 26 via the virtualization server 25. The control process 42 instructs the DB management process 43 to update the state of the business server 22 which is the notification source, and further, Instructs the view management process 45 to update the status of each business server 22 displayed on the screen portal 46. The control process 42 is an example of an “instruction unit.”

According to an instruction from the control process 42, the DB management process 43 executes referring to, updating, addition, deletion and others of Information stored in the database 44.

The view management process 45 instructs the screen portal 46 to display a status screen for displaying the status of each business server 22 or update the displayed status screen. The updating of the status screen is executed according to, for example, an instruction from the control process 42.

In response to the Instruction from the view management process 45, the screen portal 46 displays the status screen. The screen portal 46 displays information indicating, for example, whether each business server 22 connected to the inspection system 1 is normal and whether each business server 22 connected to the inspection system 1 is connected to any one of the operation LAN 11N and the quarantine LAN 10N.

The database 44 stores various tables used for the management of the inspection system 1. The database 44 is constructed on, for example, the auxiliary storage unit 103 of the switching management server 21. Referring to, updating, addition, deletion and others of the information stored in the various tables of the database 44 are executed by the control process 42 via the DB management process 43.

<Tables Stored in Database 44>

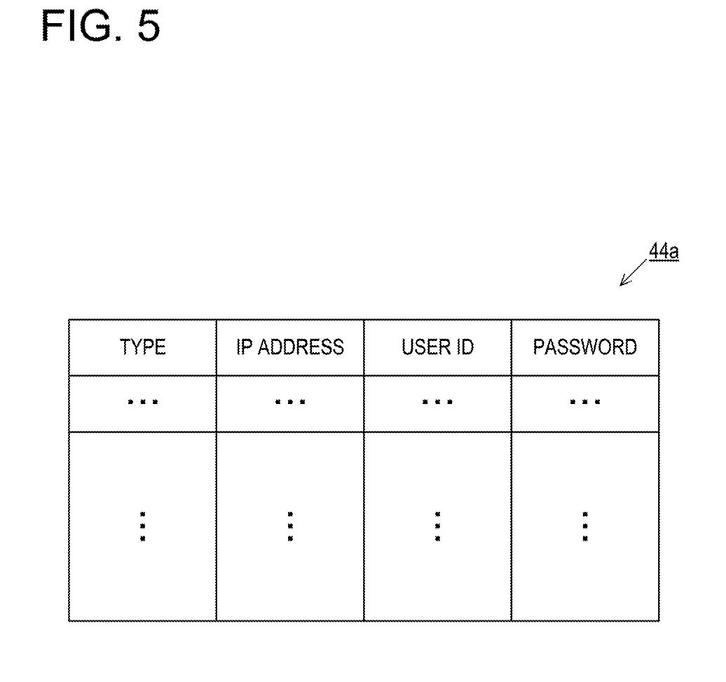

FIGS. 5 to 20 are views illustrating examples of various tables stored in the database 44. Hereinafter, examples of various tables stored in the database 44 will be described with reference to FIGS. 5 to 20.

FIG. 5 is a view illustrating an example of a management table of a virtual environment management server 44a. The management table of the virtual environment management server 44a stores, for example, information used for an access to the virtual environment management server 24. The management table of the virtual environment management server 44a is created, for example, at the construction time of the inspection system 1. The management table of the virtual environment management server 44a includes items of “Type,” “P Address,” “User ID,” and “Password.” The “Type” stores, for example, information indicating a vendor which makes the virtual environment management server 24. The “IP Address” stores, for example, an IP address of the virtual environment management server 24. The “User ID” and the “Password” store a user ID and a password used for the access to the virtual environment management server 24, respectively.

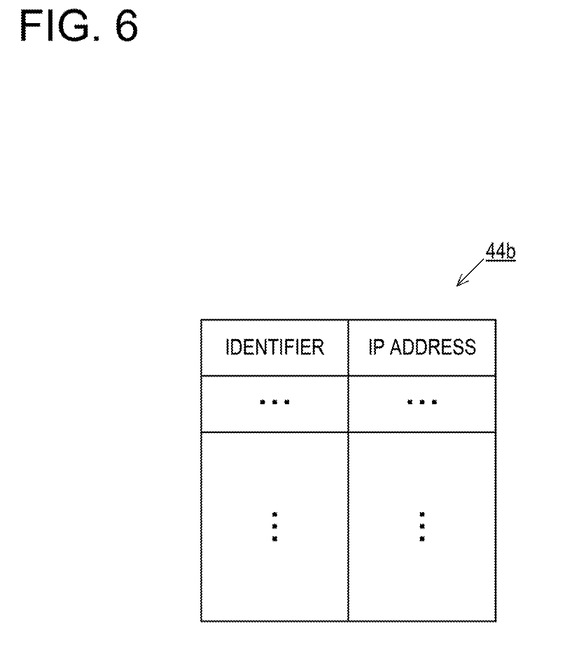

FIG. 6 is a view illustrating an example of a management table of an antivirus software management server 44b. The management table of the antivirus software management server 44b stores, for example, information used for identifying a notification from the antivirus software management server 20. The management table of the antivirus software management server 44b is created, for example, at the construction time of the inspection system 1. The management table of the antivirus software management server 44b includes items of “Identifier” and “IP Address.” The “Identifier” stores, for example, an identifier for specifying a type of the antivirus software management server 20. The “IP Address” stores, for example, an IP address of the antivirus software management server 20.

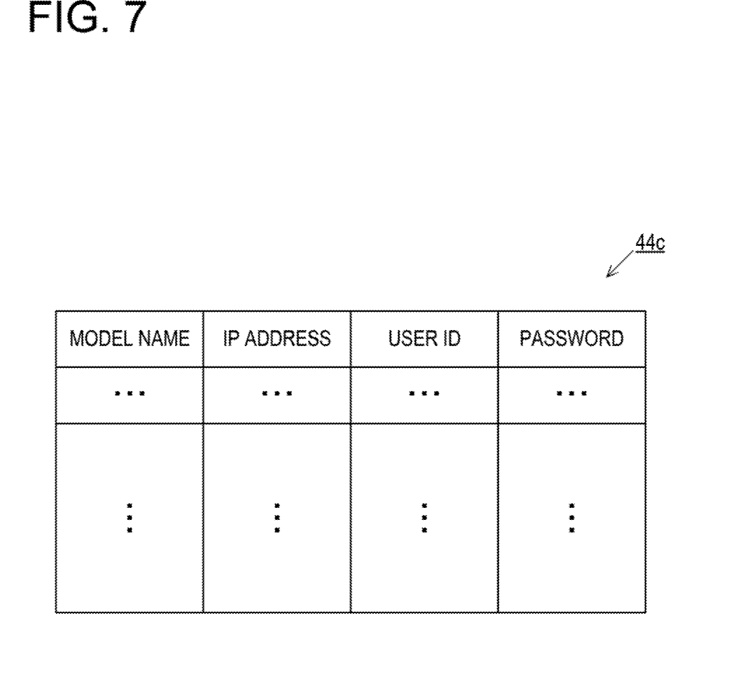

FIG. 7 is a view illustrating an example of a physical switch management table 44c. The physical switch management table 44c stores, for example, information used for an access to a physical switch such as, for example, the L2 switch 23. The physical switch management table 44c is created, for example, at the construction time of the inspection system 1. The physical switch management table 44c includes items of “Model Name,” “IP address,” “User ID,” and “Password.” The “Model Name” stores, for example, a model name of the L2 switch 23. The “IP address” stores, for example, an IP address of the L2 switch 23. The “User ID” and the “Password” store a user ID and a password used for the access to the L2 switch 23, respectively. The device whose information is registered in the physical switch management table 44c is not limited to the L2 switch 23. The device whose information is registered in the physical switch management table 44c may be, for example, a router.

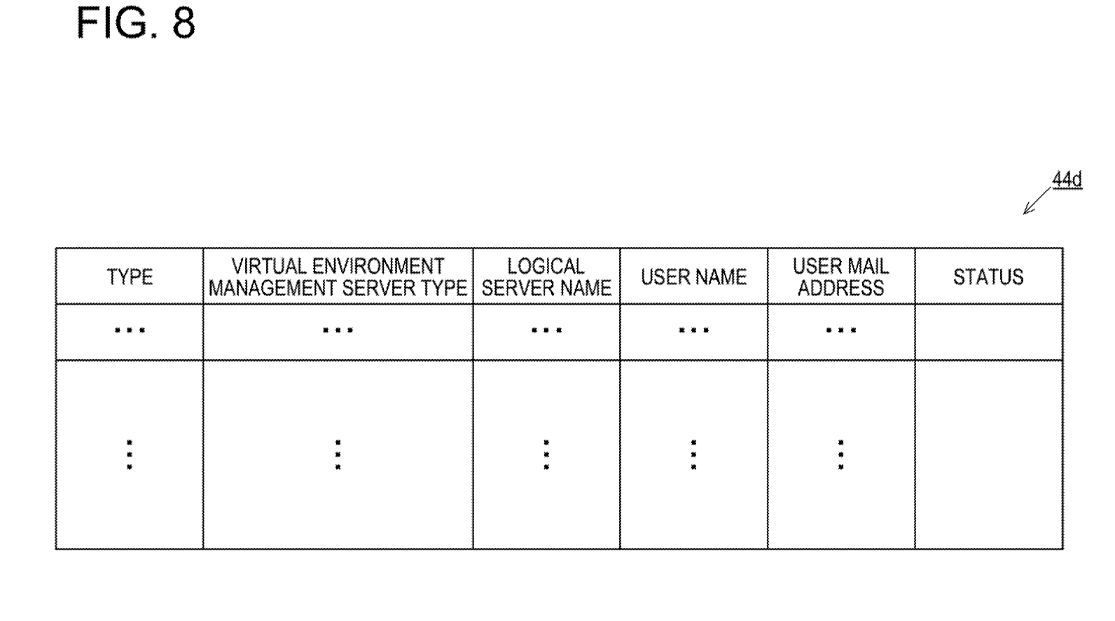

FIG. 8 is a view illustrating an example of a logical server management table 44d. The logical server is an example of a terminology referring to the business server 22 without discriminating a physical server and a virtual server. The logical server management table 44d stores, for example, information of a logical server which is a target for the connection destination network switching by the switching management server 21. The logical server management table 44d is created, for example, at the time when the logical server is connected to the inspection system 1. The logical server management table 44d includes items of “Type,” “Virtual Environment Management Server Type,” “Logical Server Name,” “User Name,” “User Mail Address,” and “Status.” The “Type” stores, for example, Information indicating a type of a virtual server or a physical server. The “Virtual Environment Management Server Type” stores, for example, information indicating a vendor of a virtual environment. The “Logical Server Name” stores a host name of the logical server. The “User Name” stores, for example, a name of the user 501 using the logical server. The “User Mail Address” store, for example, a mail address of the user 501 using the logical server. The “Status” stores, for example, information indicating a status of the logical server. The information indicating the status is, for example, Information of a normal, caution, abnormal, or inspection status. The logical server management table 44d is an example of a “user management unit.” The mail address of the user 501 is an example of “contact information.”

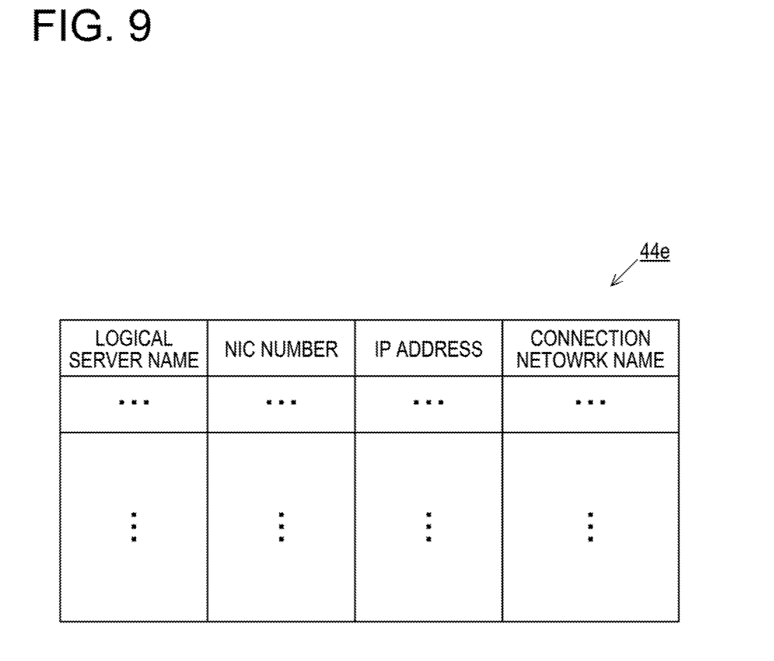

FIG. 9 is a view Illustrating an example of a management table of a logical server network 44e. The management table of the logical server network 44e stores, for example, network setting information of a logical server which is a target for the connection destination network switching by the switching management server 21. The management table of the logical server network 44e is created, for example, at the time when the logical server is created. Each record (line) of the management table of the logical server network 44e is created for each NIC equipped in the logical server. For example, information of a logical server equipped with three NICs is stored in records corresponding to three lines. The management table of the logical server network 44e includes items of “Logical Server Name,” “NIC Number,” “IP Address,” and “Connection Network Name.” The “Logical Server Name” stores, for example, a host name of the logical server. The “NIC Number” stores, for example, information for specifying the NIC equipped in the logical server. The “IP Address” stores, for example, an IP address allocated to the NIC of the logical server. The “Connection Network” stores, for example, Information specifying a network to which the NIC is connected.

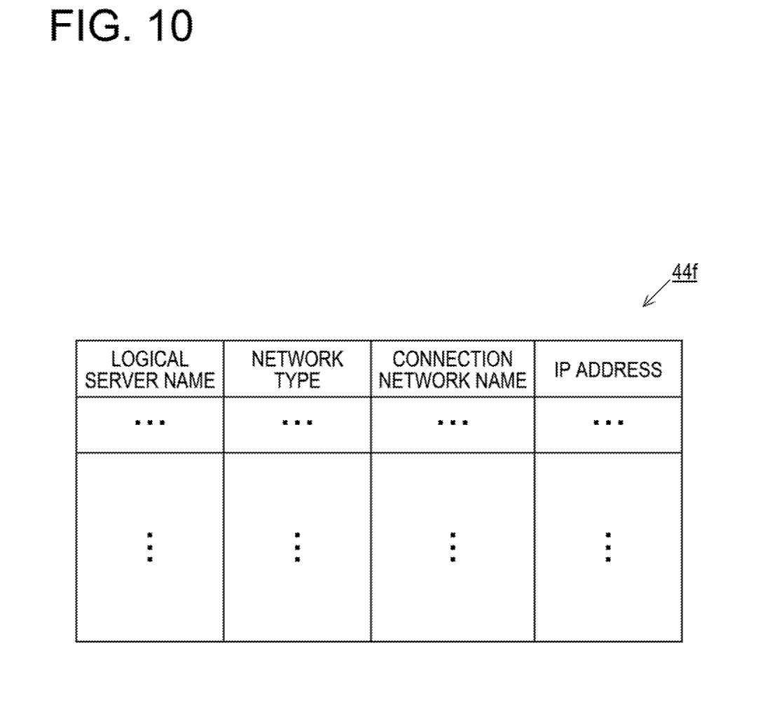

FIG. 10 is a view illustrating an example of a management table of a logical server network switching 44f. The management table of the logical server network switching 44f stores, for example, a network setting in each of a case where the logical server is connected to the inspection LAN 10N and a case where the logical server is connected to the operation LAN 11N. The management table of the logical server network switching 44f is created, for example, for each logical server. The management table of the logical server network switching 44f includes items of “Logical Server Name,” “Network Type,” “Connection Network Name,” and “IP Address.” The “Logical Server Name” stores a host name of the logical server. The “Network Type” stores, for example, a type of a network to which the logical server is connected. In the first embodiment, for example, the “Network Type” stores either information indicating the operation LAN 11N or information indicating the inspection LAN 10N. The “Connection Network Name” stores, for example, a name of a network to which the logical server is connected. The “IP Address” stores, for example, an IP address used when the logical server is connected to the network indicated by the “Network Type.”

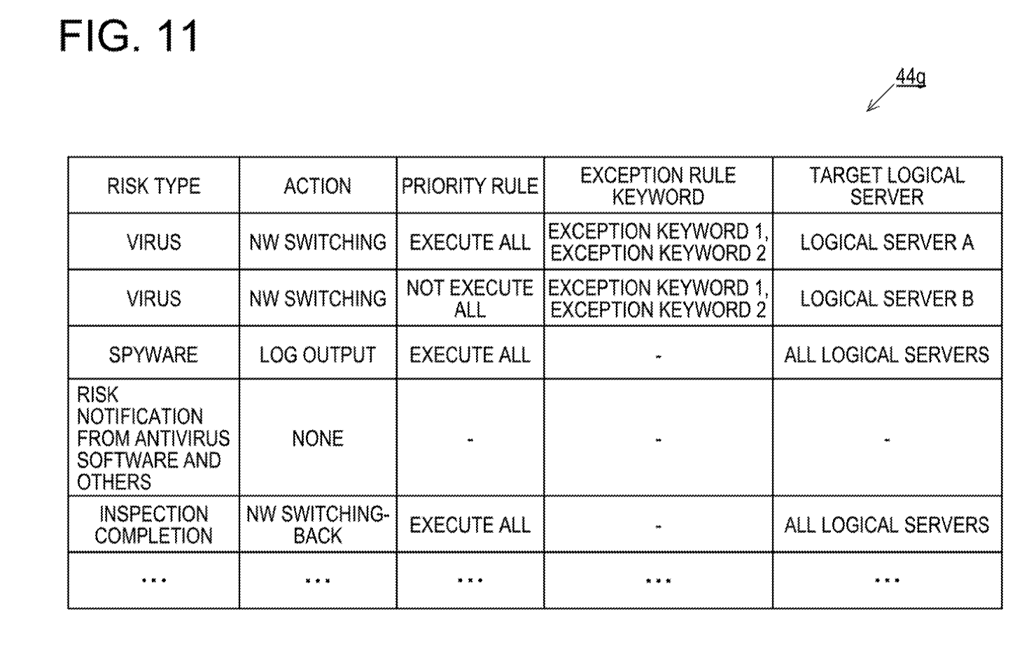

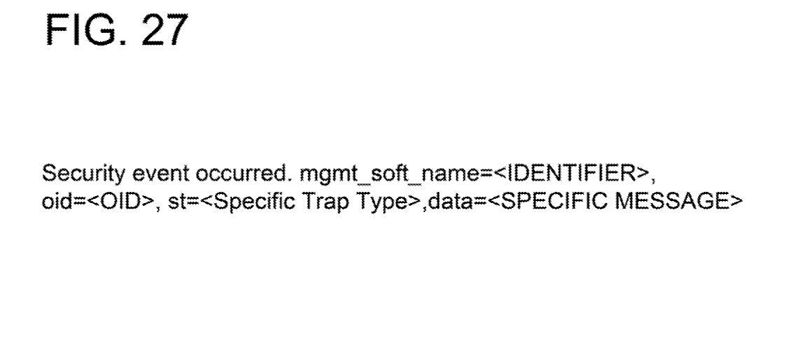

FIG. 11 is a view illustrating an example of an action customization management table 44g. The action customization management table 44g stores, for example, a process (action) in accordance with a security risk notified from the antivirus software management server 20. The action customization management table 44g includes items of “Risk Type,” “Action,” “Priority Rule,” “Exception Rule Keyword,” and “Target Logical Server.” The “Risk Type” stores, for example, information indicating a type of a risk occurring in the business server 22. The risk type is, for example, “virus,” “spyware,” “risk notification from other than antivirus software,” and “inspection completion.” The “Action” stores, for example, information indicating a process to be executed when a risk of the “Risk Type” occurs. The “Action” is, for example, “network switching,” “network switching-back,” “log output,” “none” or the like. The “Priority Rule” stores Information Indicating whether to execute the process stored in the “Action” in principle. For example, the “Priority Rule” stores “execute all” for a process which is executed in principle, and “not execute all” for a process which is not executed in principle. The “Exception Rule Keyword” stores a condition indicating an exception of the “Priority Rule.” The condition indicating the exception is, for example, a keyword. For example, in a case where the “Priority Rule” stores “execute all,” when the “Exception Rule Keyword” stores a certain keyword, and a specific message as illustrated in FIG. 27 to be described later includes the corresponding keyword, the process stored in the “Action” is not executed. For example, in a case where the “Priority Rule” stores “not execute all,” when the “Exception Rule Keyword” stores a certain keyword, and a specific message as illustrated in FIG. 27 to be described later includes the corresponding keyword, the process stored in the “Action” is executed. The “Target Logical Server” stores, for example, Information Indicating a logical server which is a target of the action. The action customization management table 44g is an example of a “countermeasure management unit.”

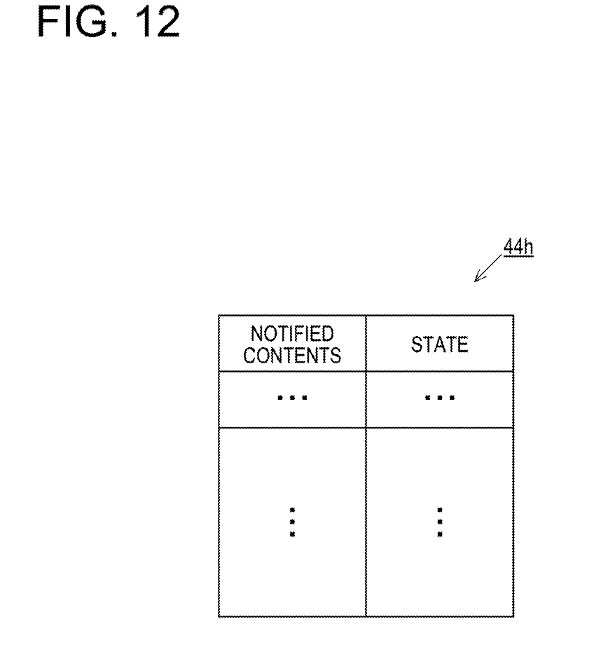

FIG. 12 is a view Illustrating an example of a notified content storage table 44h. The notified content storage table 44h stores, for example, information of a security risk notified from the antivirus software management server 20 or the like. The notified content storage table 44h is updated by the notification handler 41 that has received a notification from the antivirus software management server 20. The notified content storage table 44h includes items of “Notified Contents” and “State.” The “Notified Contents” stores, for example, information included in an SNMP trap received from the antivirus software management server 20. The “State” stores, for example, information indicating whether a process for notified contents has been completed. When the process is completed, the notified contents are deleted from the notified content storage table 44h.

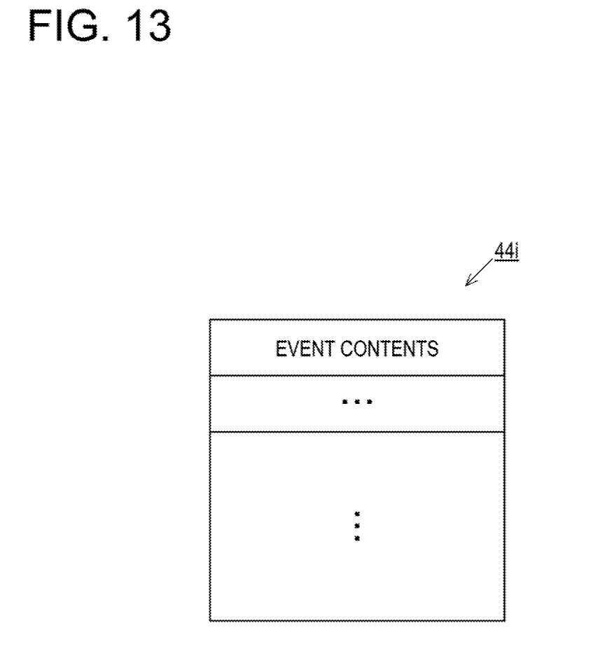

FIG. 13 is a view illustrating an example of an occurring event storage table 44i. The occurring event storage table 44i stores, for example, information on various events generated by the control process 42. The occurring event storage table 44i includes an item of “Event Contents.” The “Event Contents” stores, for example, contents of an event generated by the control process 42. The event contents are, for example, security risk notification and connection destination network switching.

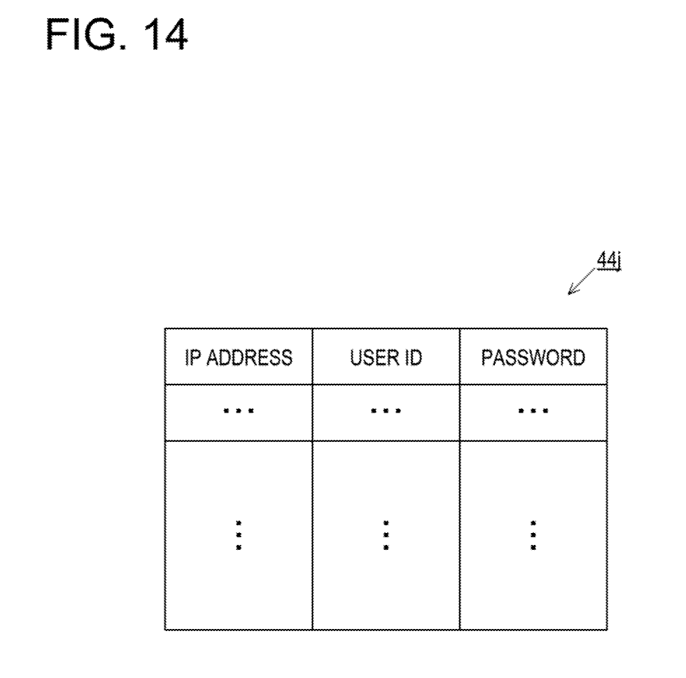

FIG. 14 is a view illustrating an example of a management table of a mail transfer server 44. The management table of the mail transfer server 44j stores, for example, information of a mail transfer server used for a mail notification to the user 501 or the like. The management table of the mail transfer server 44j includes items of “IP Address,” “User ID,” and “Password.” The “IP Address” stores an IP address of a mail transfer server. The mail transfer server is, for example, a simple mail transfer protocol (SMTP) server. The “User ID” and the “Password” store a user ID and a password used for authentication to the mail transfer server, respectively. When the mail transfer server does not require authentication, the “User ID” and the “Password” may have, for example, null values.

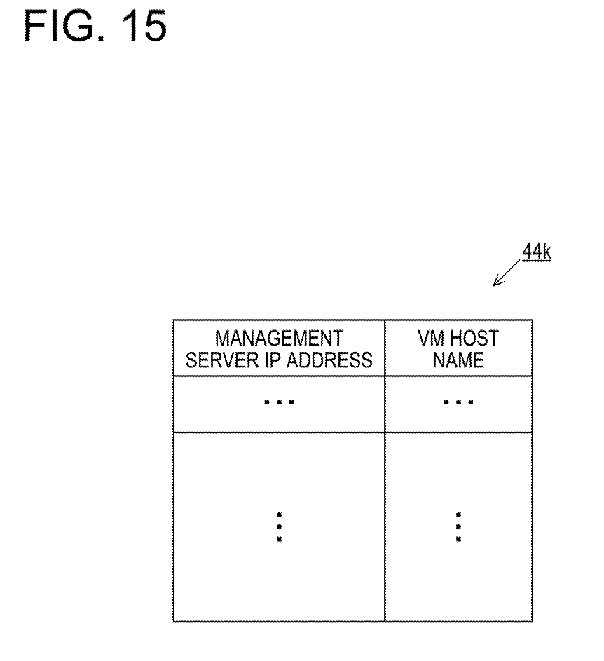

FIG. 15 is a view illustrating an example of a virtual environment management table 44k. The virtual environment management table 44k stores, for example, information of the virtualization server 25 which is acquired by the switching management server 21 from the virtual environment management server 24. The virtual environment management table 44k includes items of “Management Server IP Address” and “VM Host Name.” The “Management Server IP Address” stores an IP address of the virtual environment management server 24. The “VM Host Name” stores a host name of the virtualization server 25 which is a target to be managed by the virtual environment management server 24.

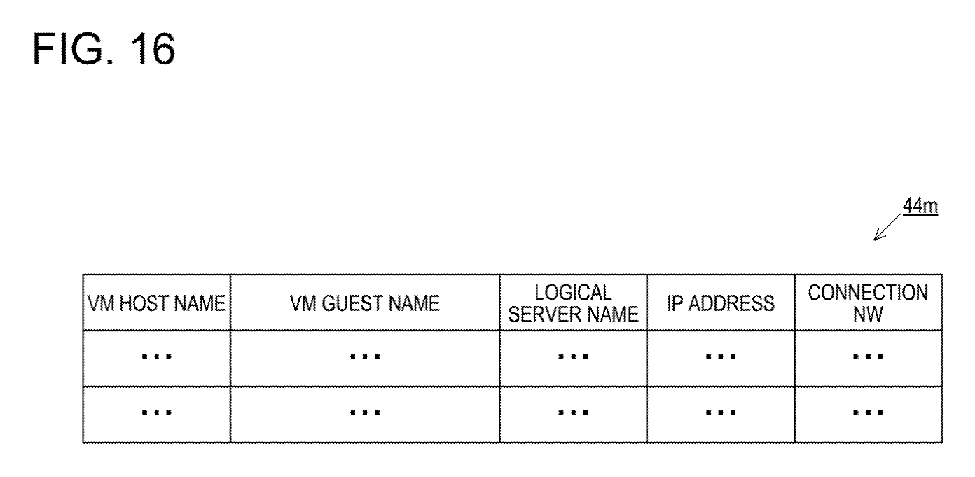

FIG. 16 is a view illustrating an example of a virtual server management table 44m. The virtual server management table 44m stores, for example, Information of a virtual server which is acquired by the switching management server 21 from the virtual environment management server 24. The virtual server management table 44m includes items of “VM Host Name,” “VM Guest Name,” “Logical Server Name,” “IP Address,” and “Connection Destination NW.” The “VM Host Name” stores a host name of the virtualization server 25. The “VM Guest Name” stores a name of a virtual server displayed on a management screen of the virtual environment management server 24. In the first embodiment, each of the business servers 22c, 22d, and 22e corresponds to the virtual server operating on the virtualization server 25. The “Logical Server Name” stores host names of the business servers 22c, 22d, and 22e which are virtual servers. The “IP Address” stores, for example, an IP address allocated to a virtual NIC of the virtual server. The “Connection NW” stores, for example, Information Indicating a network which is a connection destination of the virtual NIC.

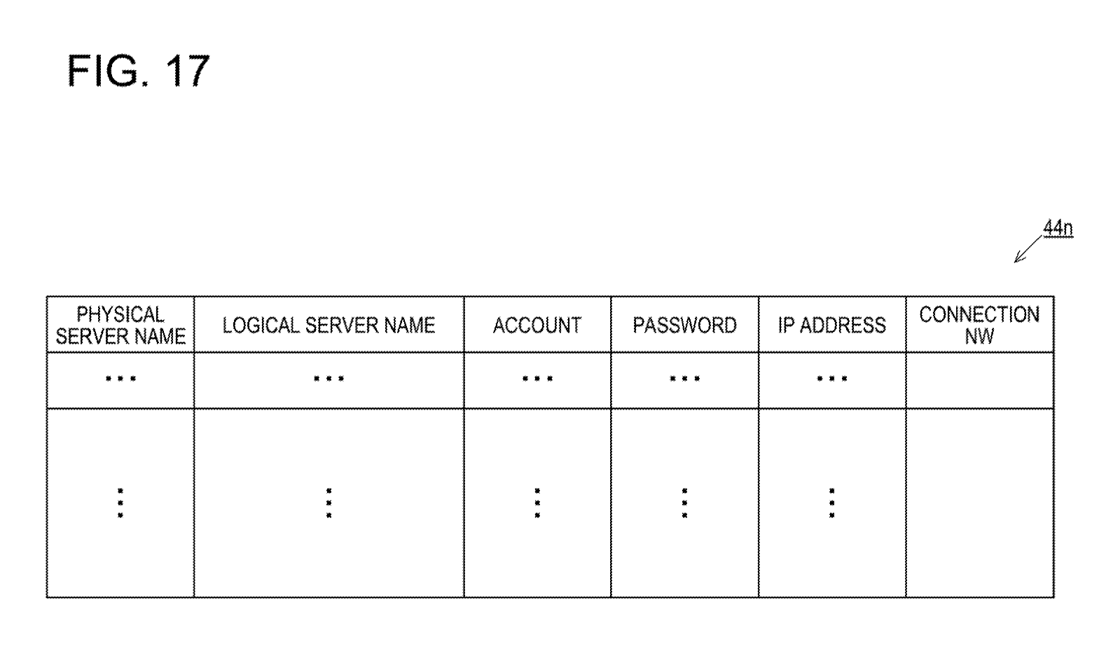

FIG. 17 is a view illustrating an example of a physical server management table 44n. The physical server management table 44n stores information acquired by the switching management server 21 from a physical server. The physical server management table 44n includes items of “Physical Server Name,” “Logical Server Name,” “Account,” “Password,” “IP Address,” and “Connection NW.” The switching management server 21 accesses a physical server, for example, the business server 22a or 22b, based on information input from the manager 500, and information collected from the physical server is stored. The “Physical Server Name” stores a name of a physical server of the business server 22 when the physical server is displayed on the screen portal. In the first embodiment, each of the business servers 22a and 22b corresponds to the physical server. The “Logical Server Name” stores a host name of the physical server having the name stored in the “Physical Server Name.” The “Account” and the “Password” store an account name and a password used for login to the OS operating on the physical server, respectively. The “IP Address” stores, for example, an IP address allocated to an NIC of the physical server. The “Connection NW” stores information indicating a network to which the NIC equipped in the physical server is connected.

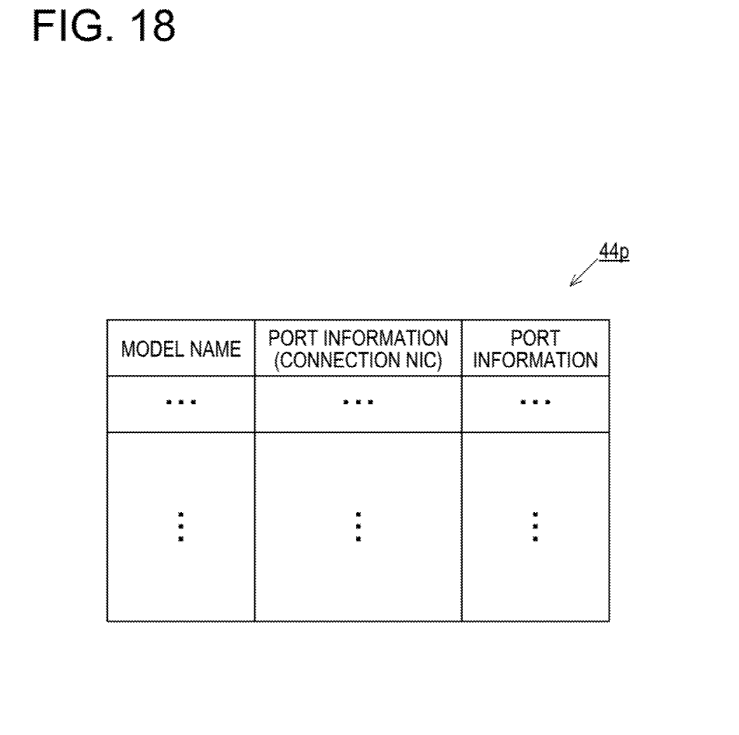

FIG. 18 is a view illustrating an example of a management table of physical switch port information 44p. The management table of the physical switch port information 44p stores port information of the physical switch. The port information is, for example, information for specifying an NIC connected to a port and a VLAN to which the port belongs. The management table of the physical switch port information 44p includes items of “Model Name,” “Port Information (Connection NIC),” and “Port Information (VLAN-ID/NW).” Each item of the management table of the physical switch port information 44p stores information collected in the manner that the manager 500 inputs the information illustrated in FIG. 7, and the switching management server 21 accesses the physical service, for example, the L2 switch 23, based on the input information and collects information. The “Model Name” stores, for example, a model name of the physical switch. The “Port Information (Connection NIC)” stores information for specifying an NIC connected to the port of the physical switch. The “Port Information (Connection NIC)” stores, for example, a MAC address of the NIC. The “Port Information (VLAN-ID/NW)” stores information for specifying a VLAN to which the port is allocated. The “Port information (VLAN-ID/NW)” stores, for example, VLAN ID.

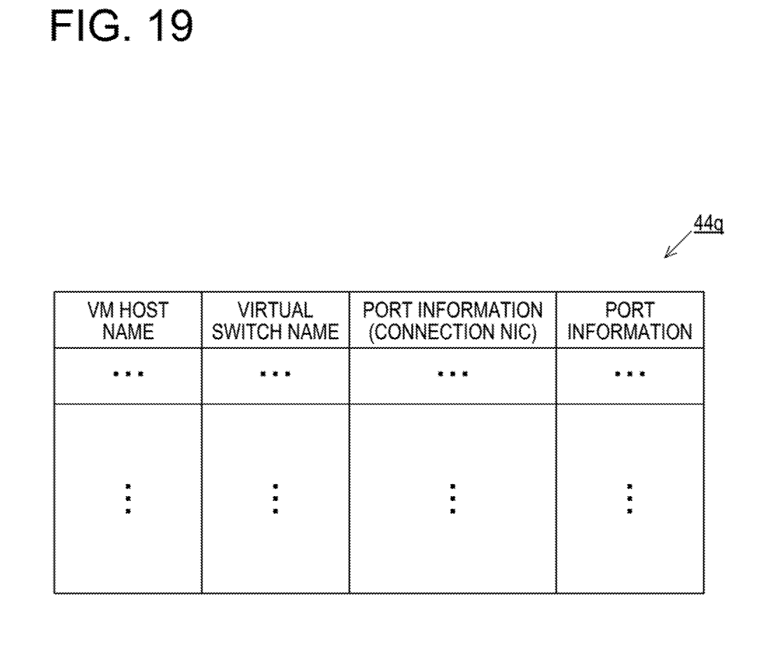

FIG. 19 is a view Illustrating an example of a management table of virtual switch port information 44q. The management table of the virtual switch port information 44q stores information of the virtual switch 26 which is acquired by the switching management server 21 from the virtual environment management server 24. The management table of the virtual switch port information 44q includes items of “VM Host Name,” “Virtual Switch Name,” “Port Information (Connection NIC),” and “Port Information (VLAN-ID/NW).” The “VM Host Name” stores, for example, a host name of the virtualization server 25 on which the virtual switch 26 operates. The “Virtual Switch Name” stores, for example, a switch name of the virtual switch 26. Since the “Port Information (Connection NIC)” and the “Port Information (VLAN-ID/NW)” are identical to the “Port Information (Connection NIC)” and the “Port Information (VLAN-ID/NW)” of FIG. 18, except that the target is a virtual environment, descriptions thereof will be omitted.

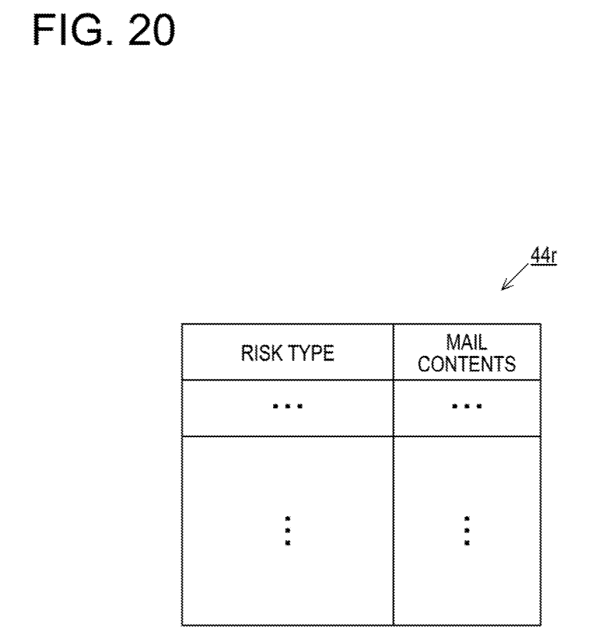

FIG. 20 is a view Illustrating an example of a mail content management table 44r. The mail content management table 44r stores contents of a mail to be notified to the user 501 when a security risk is detected. The mail content management table 44r includes items of “Risk Type” and “Mail Contents.” Each item of the mail content management table 44r is input by, for example, the manager 500. The “Risk Type” stores information Indicating a type of a security risk. The information indicating a type of a security risk is, for example, “computer virus,” “spyware,” and “inspection completion.” The “Mail Contents” stores contents written in the main text of a mail to be transferred to the user 501. The “Mail Contents” stores, for example, “virus infection,” “spyware infection” or “inspection completion.”

<Table to be Stored in Antivirus Software Management Server 20>

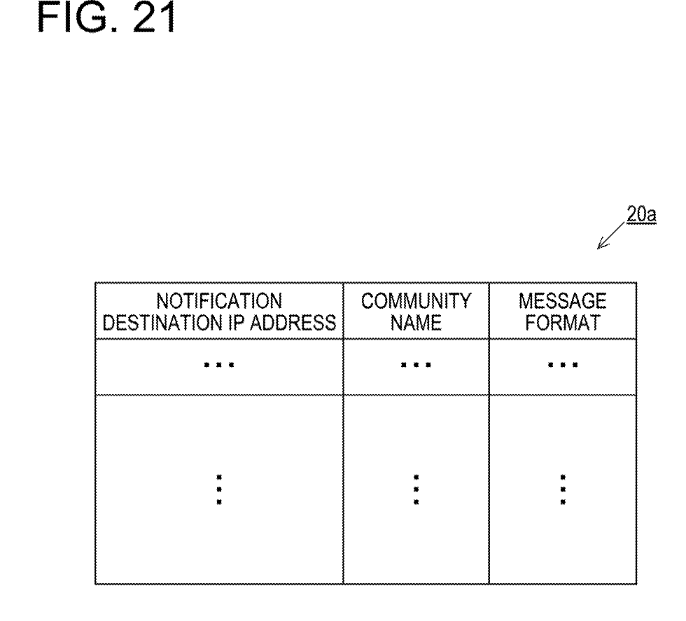

FIG. 21 is a view illustrating an example of a table to be stored in the antivirus software management server 20. Hereinafter, a table to be stored in the antivirus software management server 20 will be described with reference to FIG. 21.

FIG. 21 Is a view Illustrating an example of a definition table of an antivirus software management server 20a. The definition table of the antivirus software management server 20a includes items of “Notification Destination IP Address,” “Community Name,” and “Message Format.” The “Notification Destination IP Address” stores an IP address of a notification destination of an SNMP trap. In the first embodiment, the “Notification Destination IP Address” stores an IP address of the switching management server 21. The “Community Name” stores a community name of the notification destination of the SNMP trap. The “Message Format” stores definition of a format of a message to be notified by the SNMP trap.

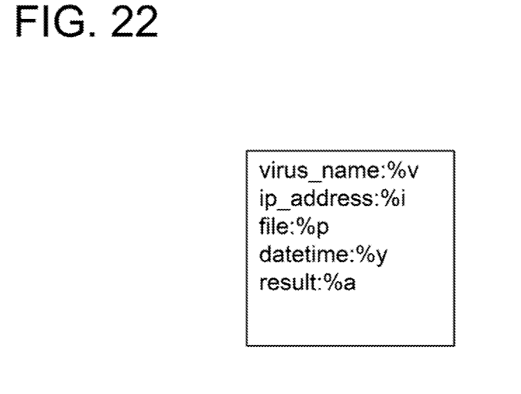

FIG. 22 is a view illustrating a first example of the “Message Format” of the definition table of the antivirus software management server 20a. FIG. 22 represents an example of a definition of a message format at the time of computer virus infection. In FIG. 22, formats of the respective items “virus_name,” “ip_address,” “file,” “datetime,” and “result” are specified. The symbol “% v” specified as the format of “virus_name” is an example of a symbol which is replaced with a name of malware (malicious software) at the time of notification. Here, the symbol “% v” is replaced with a name of a computer virus. The symbol “% i” specified as the format of “ip_address” is an example of a symbol which is replaced with an IP address of the business server 22 infected with a computer virus at the time of notification. The symbol “% p” specified as the format of “file” is an example of a symbol which is replaced with a path name of a file at the time of notification. The symbol “% y” specified as the format of “datetime” is an example of a symbol which is replaced with year, month, day, hour, minute, and second at the time of notification. The symbol “% a” specified as the format of “result” is an example of a symbol which is replaced with a predetermined character string at the time of notification. The predetermined character string is, for example, “The virus could not be disinfected (quarantined).”

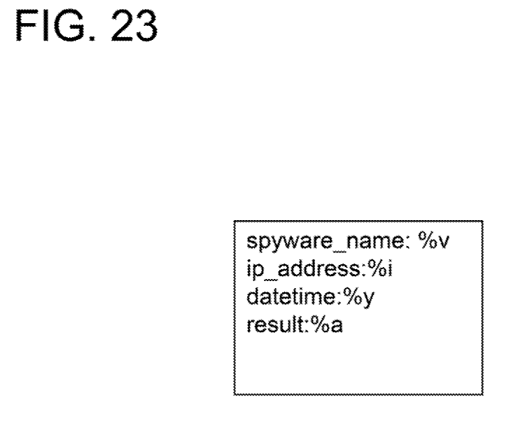

FIG. 23 is a view Illustrating a second example of the “Message Format” of the definition table of the antivirus software management server 20a. FIG. 23 represents an example of a definition of a message format at the time of spyware infection. In FIG. 23, formats of the respective items “spyware_name,” “ip_address,” “datetime,” and “result” are specified. The symbol “% v” specified as the format of “spyware_name” is an example of a symbol which is replaced with a name of malware at the time of notification. Here, the symbol “% v” is replaced with a name of spyware. The symbol “% i” specified as the format of “ip_address” is an example of a symbol which is replaced with an IP address of the business server 22 infected with spyware at the time of notification. Since “datetime” and “result” are identical to those in FIG. 22, descriptions thereof will be omitted.

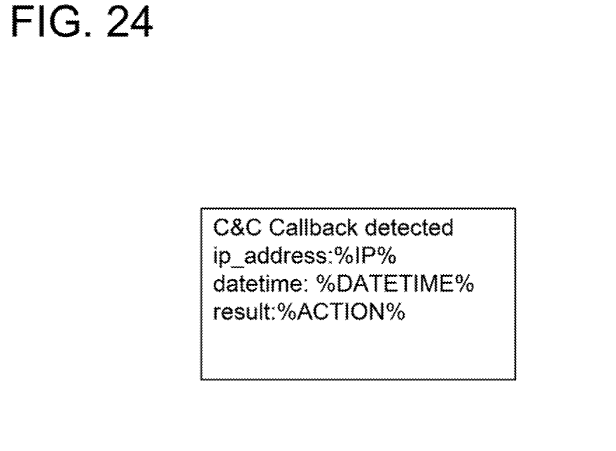

FIG. 24 is a view illustrating a third example of the “Message Format” of the definition table of the antivirus software management server 20a. FIG. 24 represents an example of a definition of a message format at the time of detection of Command & Control callback (CRC callback; suspicious connection). In FIG. 24, formats of the respective items of “ip_address,” “datetime,” and “result” are specified. The symbol “% IP %” specified as the format of “ip_address” is an example of a symbol which is replaced with an IP address of the business server 22 in which a C&C callback is detected, at the time of notification. The symbol “% DATETIME %” specified as the format of “datetime” is an example of a symbol which is replaced with year, month, day, hour, minute, and second at the time of notification. The symbol “% ACTION %” specified as the format of “result” is an example of a symbol which is replaced with a predetermined character string at the time of notification.

<SNMP Trap>

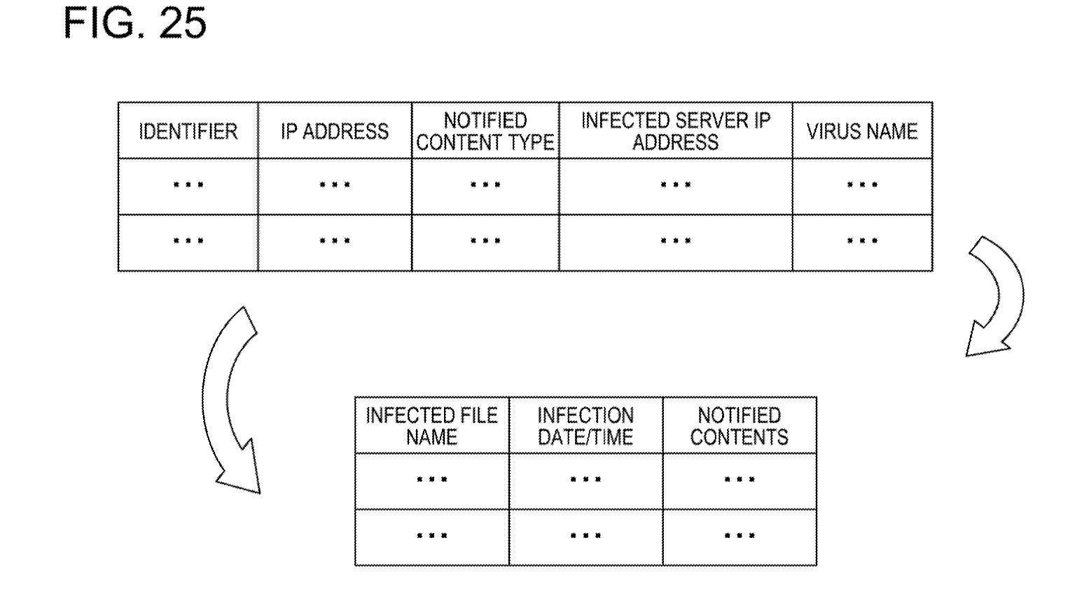

FIG. 25 is a view illustrating an example of information which is notified by an SNMP trap. The SNMP trap including the information illustrated by example in FIG. 25 is notified, for example, from the antivirus software management server 20 to the switching management server 21. The information notified by the SNMP trap includes items of “Identifier,” “IP Address,” “Notified Content Type,” “Infected Server IP Address,” “Virus Name,” “Infected File Name,” “Infection Date and Time,” and “Notified Contents.” The “Identifier” stores an identifier for specifying a type of the antivirus software management server 20. For example, the “Identifier” stores information for specifying a vendor and a product name of the antivirus software management server 20. The “IP Address” stores, for example, an IP address of the antivirus software management server 20. The “Notified Content Type” stores, for example, information indicating contents notified from the antivirus software 30. For example, the “Notified Content Type” stores information indicating a risk type such as “virus detection” and “inspection completion.” The “Infected Server IP Address” stores an IP address of the business server 22 infected with a computer virus. The “Virus Name” stores, for example, a name of a computer virus detected in the business server 22. The “Infected File Name” stores, for example, a file name of a file infected with a computer virus. The “Infection Date and Time” stores, for example, date and time of the computer virus infection. The “Notified Contents” stores texts describing details of a detected security risk. The contents of the “Infected Server IP Address,” “Virus Name,” “Infected File Name,” “Infection Date and Time,” and “Notified Contents” of the SNMP trap are defined by the “Message Format” of the definition table of the antivirus software management server 20a illustrated by example in FIG. 21. The information of the SNMP trap notified from the antivirus software management server 20 is stored in the item “Notified Contents” of the notified content storage table 44h of the switching management server 21.

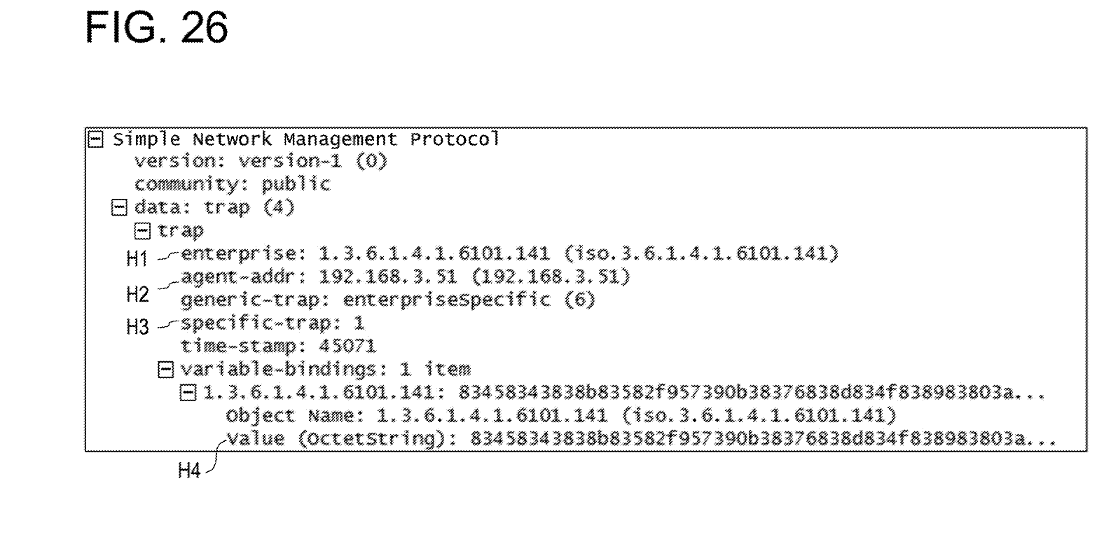

FIG. 26 is a view illustrating an example of a packet of an SNMP trap. FIG. 26 represents an example of a packet of the SNMP trap described in FIG. 25. In “enterprise” H1, an identifier for identifying the antivirus software management server 20 is stored. In “agent-addr” H2, the IP address of the antivirus software management server 20 that is illustrated by example in FIG. 6 is stored. In “specific-trap” H3, information corresponding to the “Notified Content Type” of the SNMP trap that is illustrated by example in FIG. 25 is stored. In “Value” H4, Information on a security risk notified from the antivirus software management server 20 is stored. The switching management server 21 extracts and analyzes the information stored in “Value” H4 from the SNMP trap received from the antivirus software management server 20.

FIG. 27 is a view Illustrating an example of a security risk notification to be stored in the occurring event storage table 44i by the control process 42 in response to reception of the SNMP trap. In “mgmt_soft_name,” the same information as the “enterprise” H1 is stored. In “old,” an identifier for specifying an object in the SNMP is stored. In “st,” the same information as the “specific-trap” H3 is stored. In “data,” character strings obtained by decoding the information stored in the “Value” H4 of the SNMP trap illustrated by example in FIG. 26 are stored. Specifically, the “data” stores information corresponding to the “Infected Server IP Address,” “Virus Name,” “Infected File Name,” “Infection Date and Time,” and “Notified Contents” of the SNMP trap illustrated by example in FIG. 25.

<Outline of Processes>

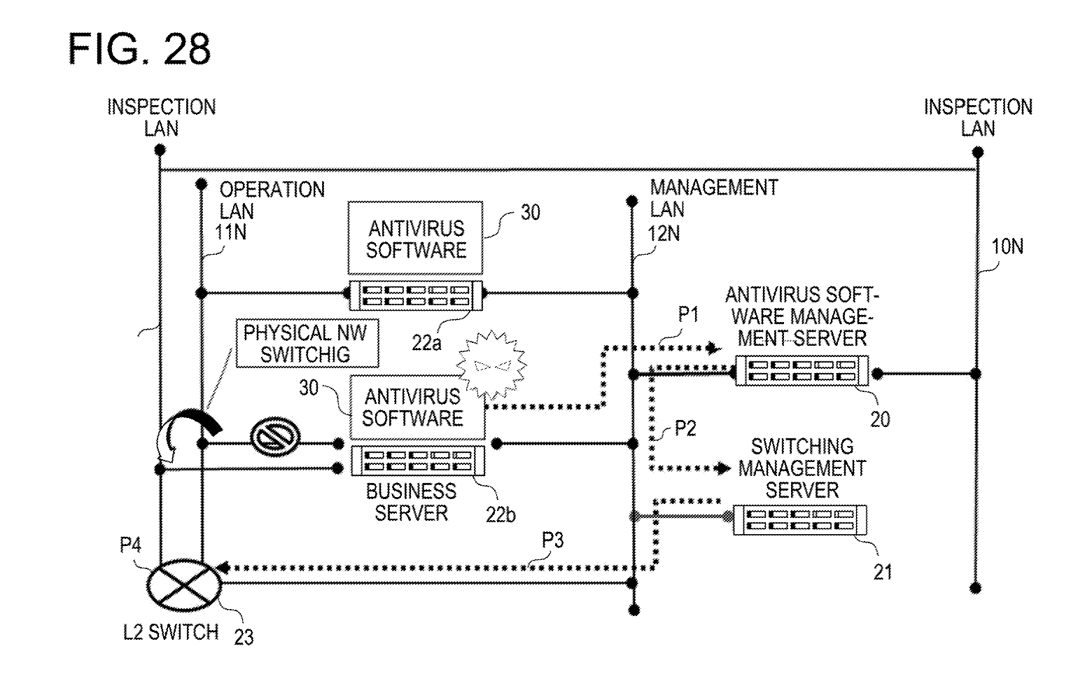

FIGS. 28 to 33 are views illustrating an example of an outline of processes of the inspection system 1 according to the first embodiment. Hereinafter, the outline of the processes of the inspection system 1 according to the first embodiment will be described with reference to FIGS. 28 to 33.

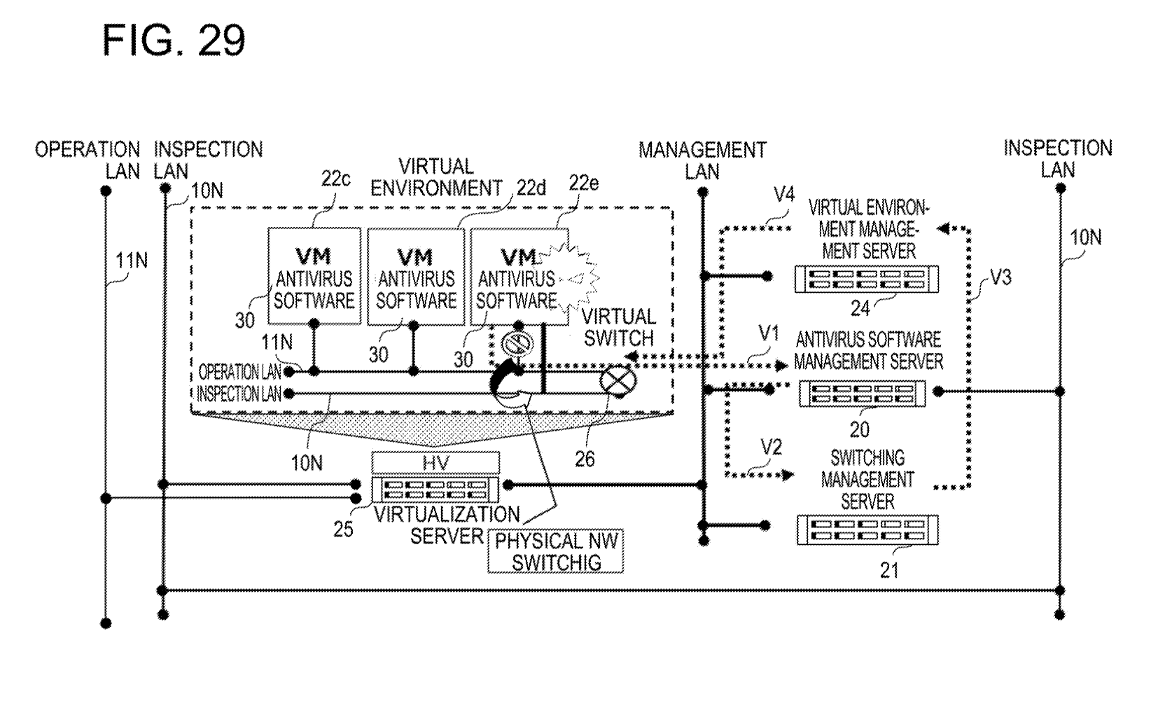

First, an outline of a network switching process according to the first embodiment will be described. FIGS. 28 and 29 are examples of views for explaining the outline of the network switching process in the first embodiment. Hereinafter, the outline of the network switching process in the first embodiment will be described with reference to FIGS. 28 and 29.

FIG. 28 is a view illustrating the outline of the network switching process in a case where the business server 22 is a physical server. In FIG. 28, it is assumed that the business server 22b is infected with a computer virus. In FIG. 28, each of the dotted lines of P1 to P3 represents an example of information exchange between the information processing apparatuses at the time of the processes from P1 to P3. In P1, the antivirus software 30 operating on the business server 22b notifies the antivirus software management server 20 that the business server 22b is infected with a computer virus. In P2, the antivirus software management server 20 notifies the switching management to server 21 that the business server 22b is infected with a computer virus. In P3, the switching management server 21 instructs the L2 switch 23 to switch the connection destination network of the business server 22b from the operation LAN 11N to the inspection LAN 10N. In P4, the L2 switch 23 changes the connection destination network of the business server 22b from the operation LAN 11N to the inspection LAN 10N by changing the setting of the VLAN.

FIG. 29 is an example of a view illustrating the outline of the network switching process in a case where the business server 22 is a virtual server. In FIG. 29, each of the dotted lines of V1 to V4 represents an example of information exchange between the information processing apparatuses at the time of the processes from V1 to V4. In FIG. 29, it is assumed that the business server 22e is infected with a computer virus. Since the processes of V1 and V2 are similar to P1 and P2 of FIG. 28, descriptions thereof will be omitted. In V3, the switching management server 21 instructs the virtual environment management server 24 to switch the connection destination network of the business server 22e from the operation LAN 11N to the inspection LAN 10N. In V4, the virtual environment management server 24 changes the connection destination network of the business server 22e from the operation LAN 11N to the inspection LAN 10N by changing the setting of the virtual switch 26 via the virtualization server 25.

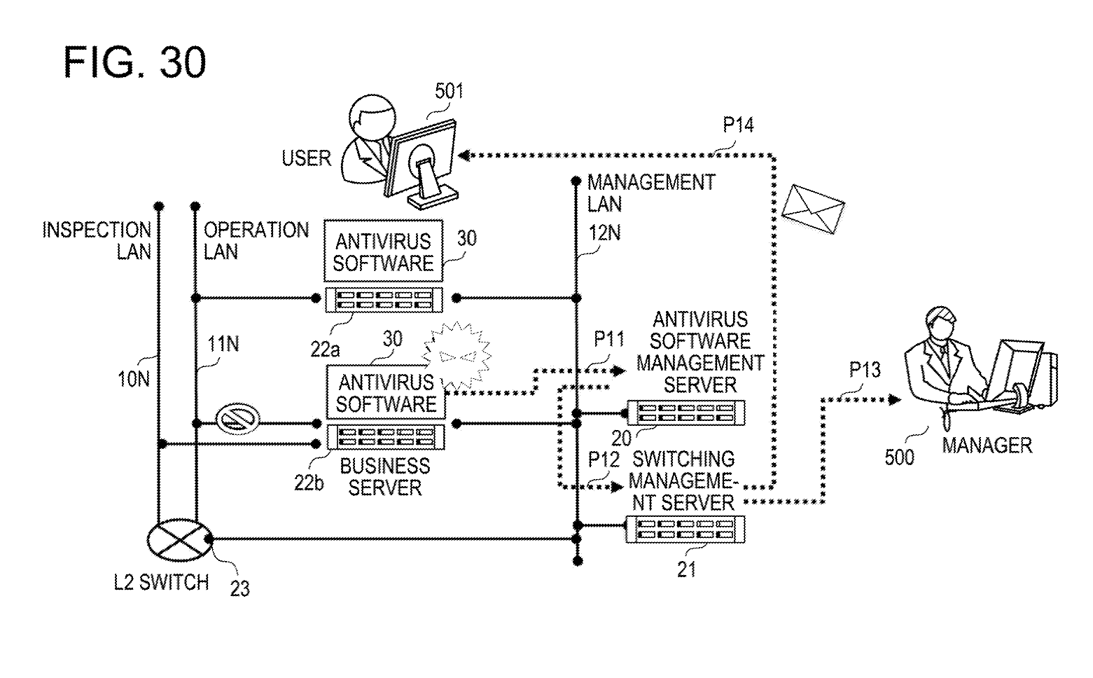

Subsequently, an outline of a notification process to the manager 500 and the user 501 according to the first embodiment will be described. FIGS. 30 to 33 are examples of views illustrating the outline of the notification process to the manager 500 and the user 501 in the first embodiment. Hereinafter, the outline of the notification process to the manager 500 and the user 501 in the first embodiment will be described with reference to FIGS. 30 to 33.

FIG. 30 is an example of a view Illustrating an outline of a notification process to the manager 500 and the user 501 at the time of computer virus infection in a case where the business server 22 is a physical server. In FIG. 30, it is assumed that the business server 22b is infected with a computer virus. In FIG. 30, each of the dotted lines of P11 to P14 represents an example of information exchange between the information processing apparatuses at the time of the processes from P11 to P14. Since the processes of P11 and P12 are similar to the processes of P1 to P2 in FIG. 28, descriptions thereof will be omitted. In P13, the switching management server 21 notifies the manager 500 of the contents notified from the antivirus software management server 20, by outputting the contents to the screen portal 46. In P14, the switching management server 21 transfers a mail stating that the business server 22b is infected with a computer virus, to the user 501.

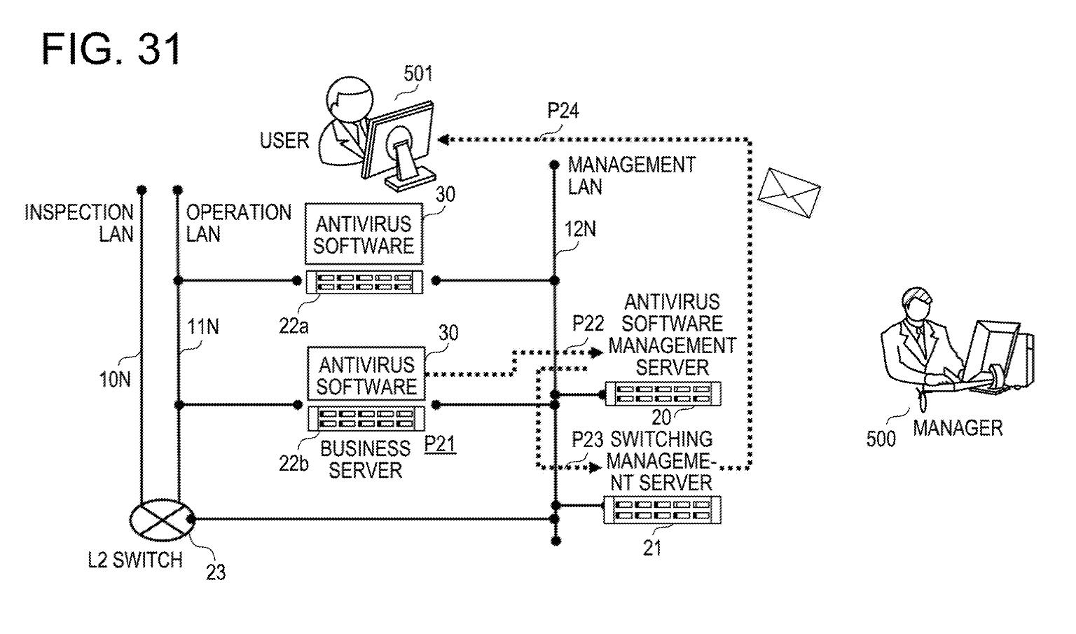

FIG. 31 is an example of a view illustrating an outline of a notification process to the user 501 at the time of inspection completion in a case where the business server 22 is a physical server. In FIG. 31, it is assumed that disinfection of the computer virus of the business server 22b has been completed, as an inspection work. In FIG. 31, each of the dotted lines of P22 to P24 represents an example of information exchange between the information processing apparatuses at the time of the processes from P22 to P24. In P21, after the inspection work, the manager 500 executes virus scanning in the business server 22b by using the antivirus software 30. In P22, when the disinfection of the computer virus is confirmed by the virus scanning executed in P21, the antivirus software 30 of the business server 22b notifies the antivirus software management server 20 of the completion of the disinfection of the computer virus. In P23, the antivirus software management server 20 notifies the switching management server 21 of the completion of the disinfection of the computer virus. In P24, the switching management server 21 transfers a mail stating that the disinfection of the computer virus has been completed, to the user 501.

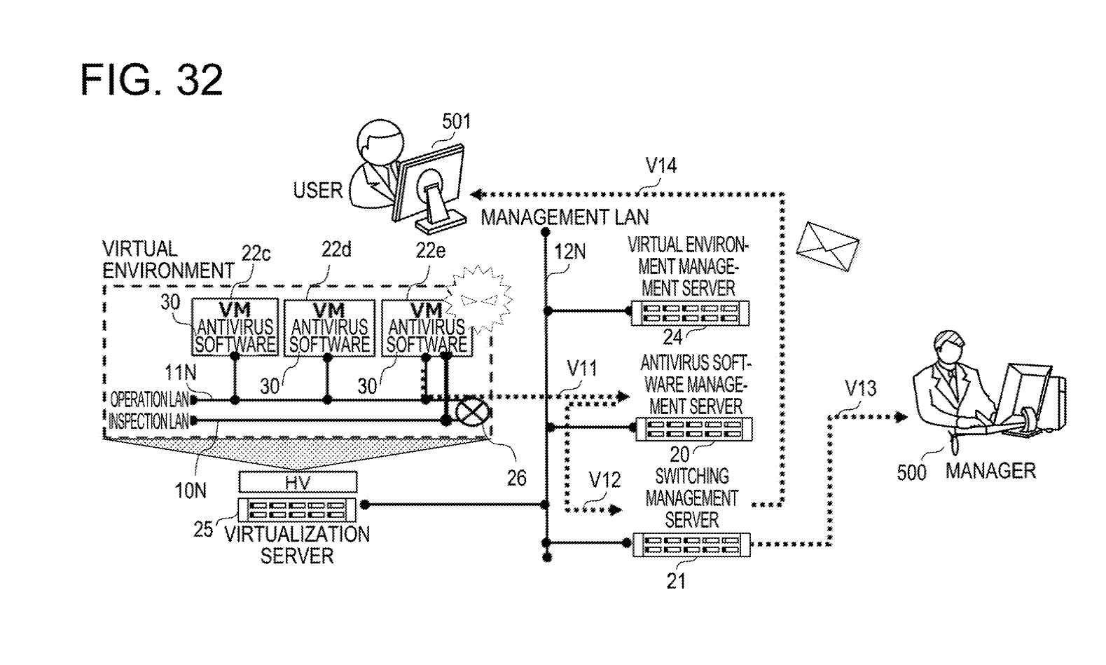

FIG. 32 is an example of a view Illustrating an outline of a notification process to the manager 500 and the user 501 at the time of computer virus infection in a case where the business server 22 is a virtual server. In FIG. 32, it is assumed that the business server 22e is infected with a computer virus. In FIG. 32, each of the dotted lines of V11 to V14 represents an example of information exchange between the information processing apparatuses at the time of the processes from V11 to V14. Since the processes from V11 to V14 are similar to the processes from P11 to P14 of FIG. 30, descriptions thereof will be omitted.

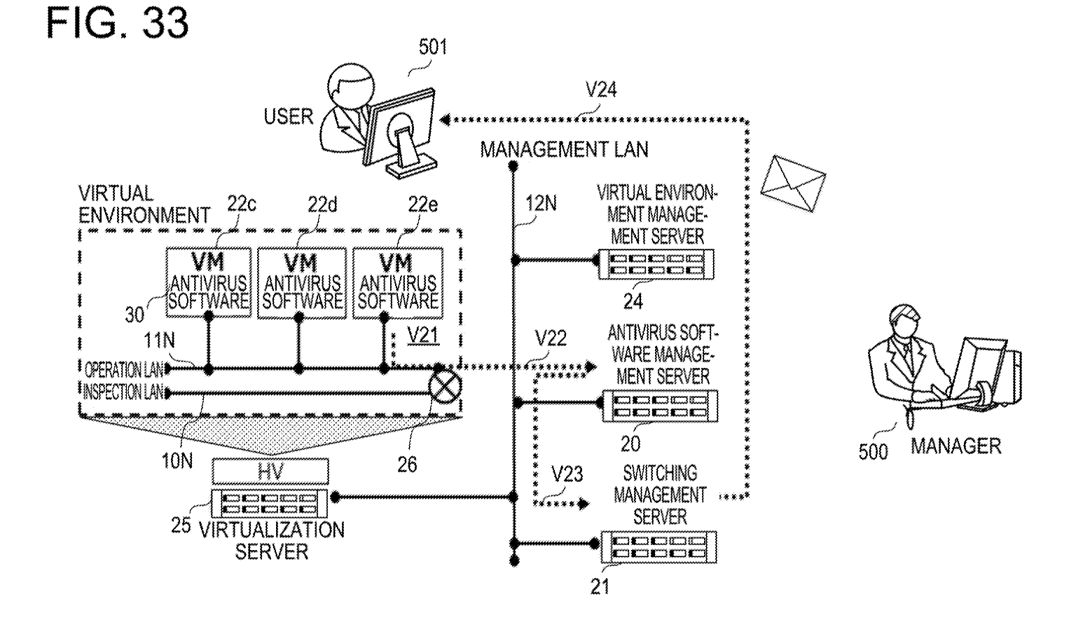

FIG. 33 is an example of a view illustrating an outline of a notification process to the user 501 at the time of inspection completion in a case where the business server 22 is a virtual server. In FIG. 33, it is assumed that disinfection of the computer virus of the business server 22e has been completed, as an inspection work. In FIG. 33, each of the dotted lines of V22 to V24 represents an example of information exchange between the information processing apparatuses at the time of the processes from V22 to V24. Since the processes from V21 to V24 are similar to the processes from P21 to P24 of FIG. 31, except that a target for virus scanning in V21 is the business server 22e, descriptions thereof will be omitted.

<Process Flow>

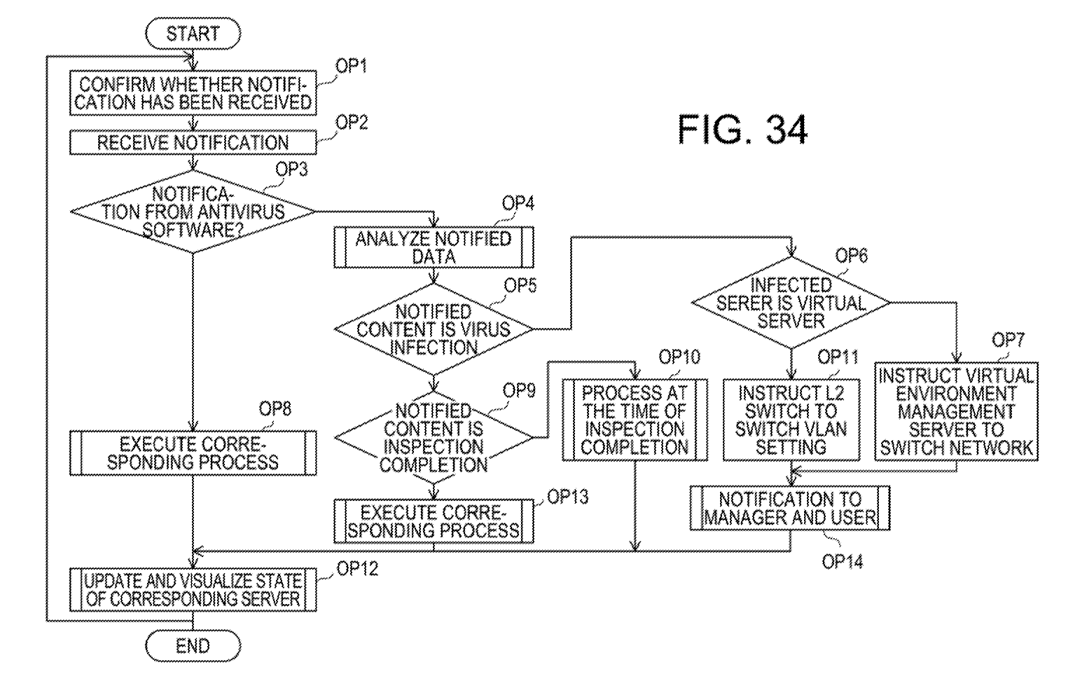

FIGS. 34 to 37 are views Illustrating an example of a process flow of the inspection system 1 according to the first embodiment. FIGS. 34 to 37 are views more specifically depicting the processes described in FIGS. 28 to 33.

FIG. 34 is a view illustrating an example of processes in the inspection system 1 according to the first embodiment. Hereinafter, descriptions will be made on an example of the processes in the inspection system 1 at the time of computer virus infection according to the first embodiment, with reference to FIG. 34.

In OP1, the notification handler 41 confirms whether a notification has been received. The notification is executed by, for example, an SNMP trap. The notification includes, for example, the information illustrated by example in the SNMP trap of FIG. 25. Upon receiving the SNMP trap, the notification handler 41 stores the received information in the “Notified Contents” of the notified content storage table 44h illustrated by example in FIG. 12. At this time, the notification handler 41 sets a value of the “State” in the notified content storage table 44h to “Unprocessed.” In addition, when there is at least one notified content having “Unprocessed” as the value of the “State” in the notified content storage table 44h, the notification handler 41 proceeds with a process of OP2.

In OP2, the notification handler 41 extracts the notification having “Unprocessed” as the value of the “State” from the notified content storage table 44h. The notification handler 41 passes the extracted notification to the control process 42.

In OP3, the control process 42 determines whether the notification received from the notification handler 41 is a notification made from the antivirus software management server 20. The control process 42 extracts, for example, information of “IP Address” and “Identifier” of the SNMP trap illustrated by example in FIG. 25, from the received notification. The control process 42 compares the extracted information of the “IP Address” and the “Identifier” with the management table of the antivirus software management server 44b. When Information matching the extracted information of the “IP Address” and the “Identifier” exists in the management table of the antivirus software management server 44b, the control process 42 determines that the corresponding notification is a notification made from the antivirus software management server 20. When it is determined that the notification is a notification made from the antivirus software management server 20 (“V” in OP3), the process proceeds to OP4. When it is determined that the notification is not a notification made from the antivirus software management server 20 (“N” in OP3), the process proceeds to OP8.

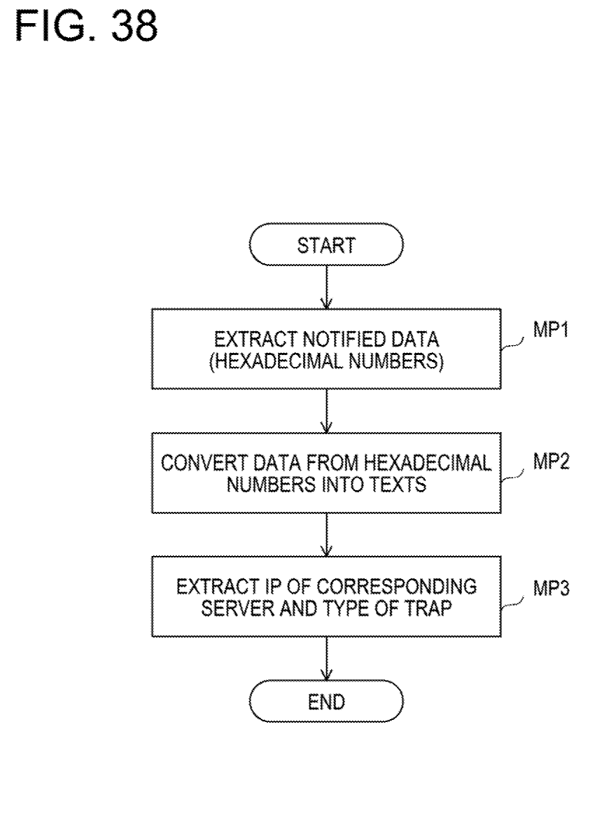

In OP4, the control process 42 analyzes the information stored in the “Notified Contents” of the received notification. Details of the process of OP4 will be described later with reference to FIG. 38.

In OP5, the control process 42 extracts a risk type stored in the “Notified Content Type” from the received notification. The control process 42 determines whether the extracted risk type is computer virus infection. When it is determined that the extracted risk type is computer virus infection (“Y” in OP5), the process proceeds to OP6. When it is determined that the extracted risk type is not computer virus infection (“N” in OP5), the process proceeds to OP9.

In OP6, the control process 42 determines whether the logical server infected with the computer virus is a physical server or a virtual server. The control process 42 extracts the IP address of the logical server stored in the “Infected Server IP Address” of the received notification. The control process 42 compares the extracted IP address with the management table of the logical server network 44e illustrated by example in FIG. 9, so as to acquire a logical server name set for the logical server of the extracted IP address. The control process 42 compares the acquired logical server name with the logical server management table 44d Illustrated by example in FIG. 8, so as to determine whether the logical server is a virtual server. When it is determined that the logical server is a virtual server (“Y” in OP6), the process proceeds to OP7. When it is determined that the logical server is not a virtual server (“N” in OP6), the process proceeds to OP11.

In OP7, the control process 42 instructs the virtual environment management server 24 to change the setting of the virtual switch 26 such that the logical server infected with the computer virus is connected to the inspection LAN 10N. Upon receiving the instruction, the virtual environment management server 24 transfers the received instruction to the virtualization server 25. Upon receiving the instruction from the virtual environment management server 24, the virtualization server 25 changes the setting of the virtual switch 26 such that the logical server infected with the computer virus is connected to the inspection LAN 10N.

In OP8, the control process 42 analyzes the received notification and extracts the type of the security risk. The control process 42 extracts the “Action” associated with the extracted type of the security risk from the action customization management table 44g illustrated by example in FIG. 11. The control process 42 executes the process designated by the extracted “Action.”

In OP9, the control process 42 extracts the risk type stored in the “Notified Content Type” from the received notification. The control process 42 determines whether the extracted risk type is inspection completion. When it is determined that the risk type is inspection completion (“Y” in OP9), the process proceeds to OP10. When it is determined that the risk type is not inspection completion (“N” in OP9), the process proceeds to OP13.

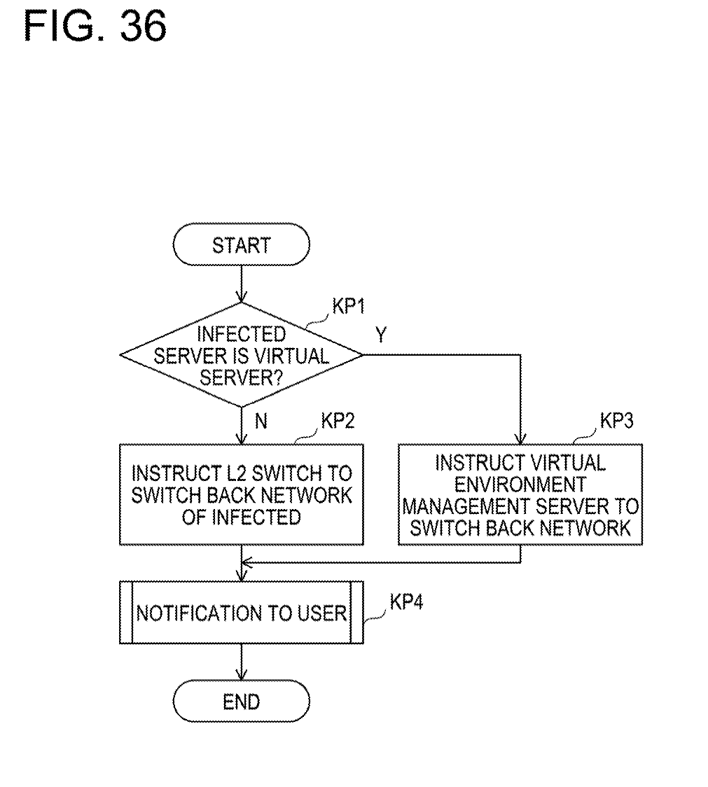

In OP10, the control process 42 executes the process at the time of inspection completion. Details of the process of OP10 will be described later with reference to FIG. 36.

In OP11, the control process 42 instructs the L2 switch 23 to change the setting of the VLAN such that the logical server infected with the computer virus is connected to the inspection LAN 10N.

In OP12, the control process 42 updates the “Status” of the logical server management table 44d illustrated by example in FIG. 8. The control process 42 instructs the view management process 45 to output the updated information of the logical server management table 44d to the screen portal 46. The view management process 45 outputs the updated information of the logical server management table 44d to the screen portal 46.

In OP13, the control process 42 extracts the “Action” associated with the risk type extracted in OP4 from the action customization management table 44g Illustrated by example in FIG. 11. The control process 42 executes the process designated by the extracted “Action.”

In OP14, the control process 42 notifies the manager 500 and the user 501 of the logical server infected with the computer virus. The control process 42 executes the notification to the manager 500 by outputting the status of the logical server to the screen portal 46 via the view management process 45. Further, the control process 42 transfers a mail notifying that the logical server being used by the user 501 is infected with the computer virus, to the mail address of the user 501.

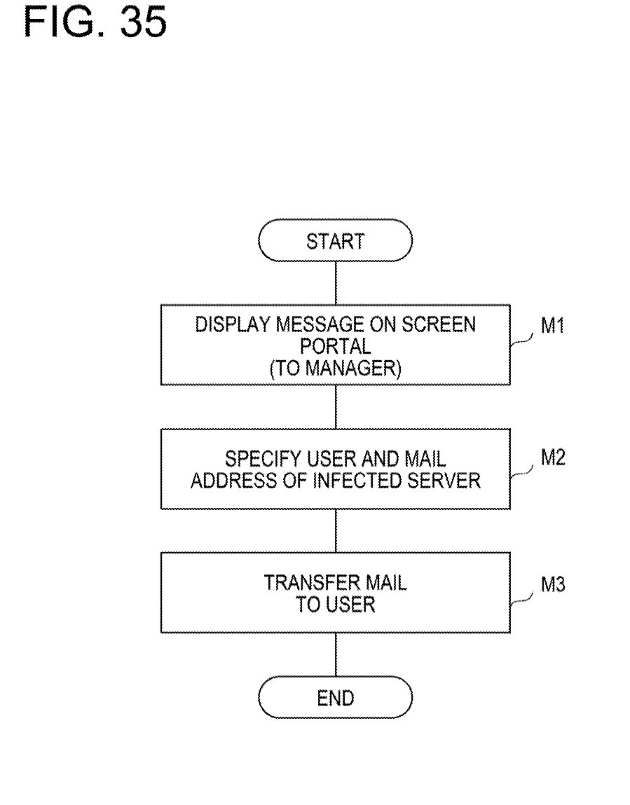

FIG. 35 is a view illustrating an example of a notification process to the manager 500 and the user 501 at the time when the logical server is infected with a computer virus. FIG. 35 is an example of a view more specifically Illustrating the process of OP14 of FIG. 34. Hereinafter, descriptions will be made on an example of the notification process to the manager 500 and the user 501 at the time when the logical server is infected with a computer virus, with reference to FIG. 35.

In M1, the control process 42 updates the occurring event storage table 44i illustrated by example in FIG. 13. The control process 42 instructs the view management process 45 to output the updated information of the occurring event storage table 44i to the screen portal 46. The view management process 45 makes a notification to the manager 500 by outputting the information stored in the updated occurring event storage table 44i to the screen portal 46.

In M2, the control process 42 refers to the logical server management table 44d Illustrated by example in FIG. 8, and specifies the user name and the user mail address of the logical server infected with the computer virus. The control process 42 refers to the management table of the mail transfer server 44j illustrated by example in FIG. 14, and specifies the mail transfer server to be used for mail transfer.

In M3, the control process 42 transfers a mail stating that the logical server being used by the user 501 is infected with the computer virus, to the mail address of the user 501 based on the Information specified in M2.

FIG. 36 is a view Illustrating an example of processes after inspection of a computer virus in the inspection system 1 according to the first embodiment. FIG. 36 depicts the process of OP10 of FIG. 34 in more detail. Hereinafter, descriptions will be made on an example of the processes after inspection of a computer virus in the inspection system 1 according to the first embodiment, with reference to FIG. 36.

In KP1, the control process 42 determines whether the logical server infected with the computer virus is a physical server or a virtual server, by executing the same process as OP7 of FIG. 34. When it is determined that the logical server is a virtual server (“Y” in KP1), the process proceeds to KP3. When it is determined that the logical server is not a virtual server (“N” in KP1), the process proceeds to KP2.

In KP2, the control process 42 instructs the L2 switch 23 to change the setting of the VLAN such that the inspected logical server is connected to the operation LAN 11N.

In KP3, the control process 42 instructs the virtual environment management server 24 to change the setting of the virtual switch 26 such that the inspected logical server is connected to the operation LAN 11N. Upon receiving the instruction from the control process 42, the virtual environment management server 24 changes the setting of the virtual switch 26 such that the inspected logical server is connected to the operation LAN 11N via the virtualization server 25.

In KP4, the control process 42 notifies the user 501 of the inspection completion of the logical server. The control process 42 transfers a mail notifying the inspection completion of the logical server being used by the user 501, to the mail address of the user 501.

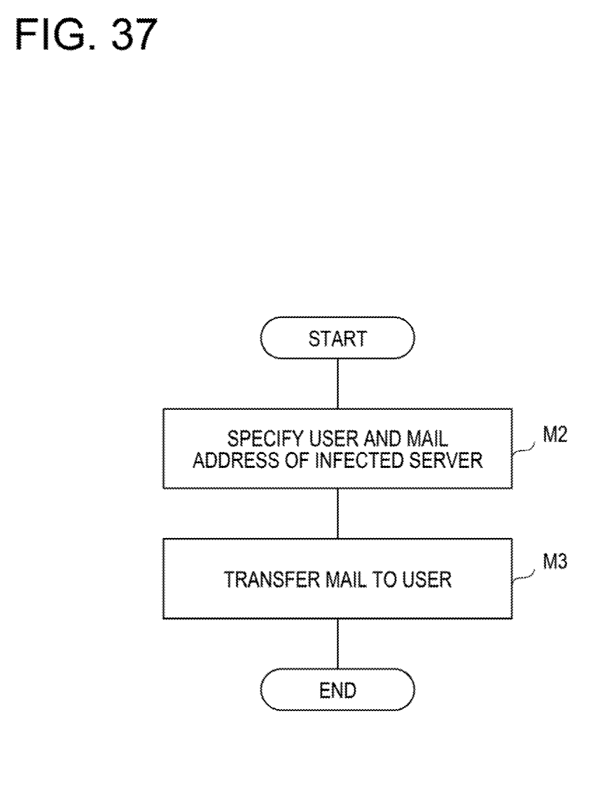

FIG. 37 is a view illustrating an example of a notification process to the user 501 after completion of inspection of the logical server. FIG. 37 is an example of a view more specifically Illustrating the process of KP4 of FIG. 36. Since the respective processes of FIG. 37 are similar to the processes of M2 and M3 of FIG. 35, except that contents of a mail to be transferred notify the inspection completion, descriptions thereof will be omitted.

<Process of Analyzing Notification in Switch Management Server 21>

FIG. 38 is a view illustrating an example of a process of analyzing the notification received by the switching management server 21. FIG. 38 is an example of a view for explaining details of the process of OP4 in FIG. 34. The notification is executed by, for example, an SNMP trap. The SNMP trap includes, for example, the information illustrated by example in FIG. 25. A packet of the SNMP trap is illustrated by example in FIG. 26. Hereinafter, the process of analyzing the notification in the switching management server 21 will be described with reference to FIG. 38.

In MP1, the control process 42 extracts the information stored in the “Value” H4 of the packet illustrated by example in FIG. 26. The extracted information is, for example, enumeration of data expressed in hexadecimal numbers. In MP2, the control process 42 converts the information extracted in MP1 into a character string by decoding the information. In MP3, the control process 42 extracts information stored in each of the items “Infected Server IP Address” and “Notified Content Type” from the Information decoded in MP2.

<Work Flow from Construction to Operation of Inspection System 1>

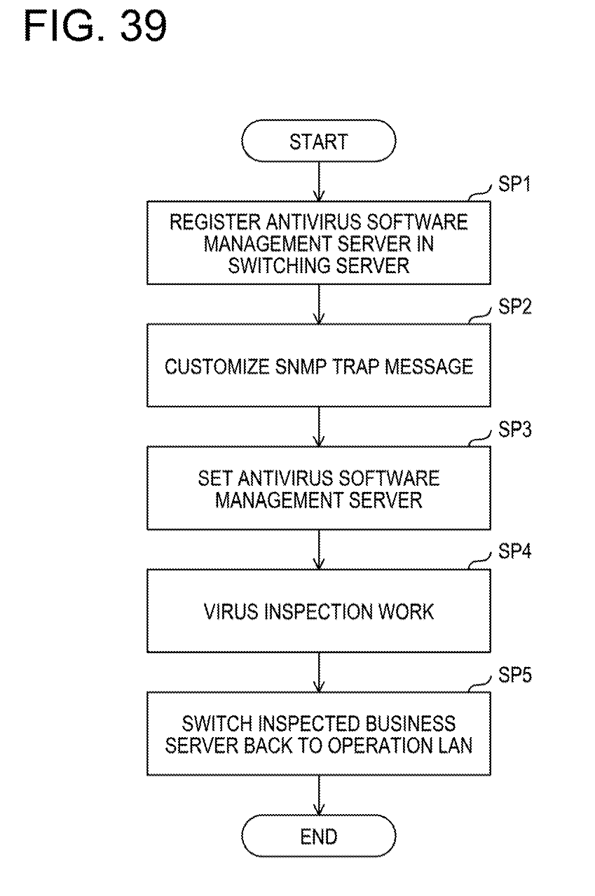

FIG. 39 is a view illustrating an example of a work flow from the construction to the operation of the inspection system 1 which is performed by the manager 500. Hereinafter, descriptions will be made on an example of the work flow from the construction to the operation of the inspection system 1 which is performed by the manager 500, with reference to FIG. 39.

The processes from SP1 to SP3 are an example of the work flow which is performed at the initial setting of the inspection system 1. In SP1, the manager 500 registers the antivirus software management server 20 in the switching management server 21. Specifically, the manager 500 registers the identifier and the IP address for identifying the antivirus software management server 20 in the management table of the antivirus software management server 44b illustrated by example in FIG. 6.

In SP2, the manager 500 customizes a message of an SNMP trap. Specifically, the manager 500 defines a format of a message to be notified to the “Message Format” of the definition table of the antivirus software management server 20a illustrated by example in FIG. 21. The definition is performed in the formats illustrated by example in FIGS. 22 to 24.

In SP3, the manager 500 performs a setting of the antivirus software management server 20. Specifically, the manager 500 stores information in each of the items “Notification Destination IP Address” and “Community Name” in the definition table of the antivirus software management server 20a illustrated by example in FIG. 21.

The processes of SP4 and SP5 are examples of the work flow which is executed at the time of the operation of the inspection system 1. In SP4, the connection destination network of the logical server infected with the computer virus is switched to the inspection LAN 10N. The manager 500 performs the inspection work including investigation of the logical server connected to the inspection LAN 10N and disinfection of the computer virus. After performing the inspection work, the manager 500 confirms whether the computer virus of the logical server is disinfected, by using the antivirus software management server 20 connected to the inspection LAN 10N.

In SP5, the manager 500 switches the connection destination network of the logical server from which the computer virus has been disinfected, back to the operation LAN 11N from the inspection LAN 10N.

<Effects of First Embodiment>

In the first embodiment, when a logical server is Infected with a computer virus, the antivirus software 30 operating on the corresponding logical server makes a notification to the antivirus software management server 20. Upon receiving the notification, the antivirus software management server 20 makes a notification to the switching management server 21 by using an SNMP trap. Upon receiving the SNMP trap, the switching management server 21 switches the connection destination network of the logical server infected with the computer virus from the operation LAN 11N to the inspection LAN 10N. Thus, according to the first embodiment, the influence of the computer virus on the operation LAN 11N is suppressed.

In the first embodiment, the antivirus software management server 20 is connected to the inspection LAN 10N. Thus, according to the first embodiment, the manager 500 is able to easily perform the inspection work of the logical server, as compared with a case where a network for the inspection work of the logical server infected with the computer virus is separately provided.

In the first embodiment, as illustrated by example in FIG. 11, an action may be defined for each detected risk type. Thus, according to the first embodiment, it is also possible to cope with security risks other than computer virus infection.

In the first embodiment, notified contents are stored in the notified content storage table 44h illustrated by example in FIG. 12. In the notified content storage table 44h, when the notified contents are unprocessed, the item of “State” stores information Indicating the unprocessed contents. Thus, even in a case where the switching management server 21 is stopped due to power outage or the like, the switching management server 21 is capable of extracting the unprocessed notified contents and executing the process for the extracted unprocessed notified contents, after being powered on.

In the first embodiment, the switching of the connection destination networks of the business servers 22a, 22b, and 22c that are physical servers is implemented in the manner that the switching management server 21 instructs the L2 switch 23 to change the setting of the VLAN. Further, the switching of the connection destination networks of the business servers 22d and 22e that are virtual servers is implemented in the manner that the switching management server 21 instructs the virtual environment management server 24 to change the setting of the virtual switch 26. Thus, according to the first embodiment, it is possible to perform the switching of a connection destination network for any of a physical server and a virtual server.

In the first embodiment, when a connection destination network of a logical server infected with a computer virus is switched, the switching is notified to the manager 500 by using the screen portal 46. Thus, according to the first embodiment, the manager 500 is able to start coping with the logical server infected with the computer virus at an early stage.

In the first embodiment, when switching a connection destination network of a logical server infected with a computer virus, the switching management server 21 makes a mail notification to the user 501 of the corresponding logical server. Thus, according to the first embodiment, the user 501 is able to easily grasp the circumstance when the connection destination network of the logical server is switched.

<Modifications>

In the first embodiment, by switching a connection destination network of a logical server infected with a computer virus from the operation LAN 11N to the inspection LAN 10N, a damage caused by the computer virus is suppressed from being expanded to other logical servers. However, as the method of suppressing the expansion of the damage caused by the computer virus, for example, a connection destination network of a logical server which is not infected with a computer virus may be switched to the inspection LAN 10N. In other words, a connection destination network of a logical server may be switched such that a logical server Infected with a computer virus and a logical server not infected by a computer virus are connected to different networks.

In the first embodiment, the antivirus software management server 20 is not connected to the operation LAN 11N. However, the antivirus software management server 20 may be connected to the operation LAN 11N.

In the first embodiment, the screen portal 46 is used for the notification to the manager 500. However, the means used for the notification to the manager 500 is not limited to the screen portal 46. The notification to the manager 500 may be, for example, information output to a system log of a computer system which is exemplified by syslog.

In the first embodiment, a mail is used for the notification to the user 501. However, the means used for the notification to the user 501 is not limited to a mail. As the means used for the notification to the user 501, for example, dialog may be displayed on a desktop screen of a computer used by the user 501.

In the first embodiment, in a network of a physical server, the VLAN of the L2 switch 23 is used for the switching of the connection destination network. However, the switching of the connection destination network is not limited to the method using the VLAN of the L2 switch 23. The switching of the connection destination network may be controlled by using, for example, openflow.

In the first embodiment, the manager 500 performs the switching-back of the inspected logical server from the inspection LAN 10N to the operation LAN 11N. However, the manager 500 may not perform the switching-back of the Inspected logical server from the inspection LAN 10N to the operation LAN 11N. For example, when the result of the virus scanning by the antivirus software 30 for the inspected logical server is normal, the antivirus software 30 notifies the antivirus software management server 20 that the result of the virus scanning is normal. The antivirus software management server 20 notifies the switching management server 21 that the result of the virus scanning is normal, by using an SNMP trap. The switching management server 21 may instruct the L2 switch 23 or the virtual environment management server 24 to change the connection destination network of the logical server which is normal in the result of the virus scanning, from the inspection LAN 10N to the operation LAN 11N.

The foregoing embodiments or modifications may be combined with each other.

All examples and conditional language recited herein are intended for pedagogical purposes to aid the reader in understanding the disclosure and the concepts contributed by the inventor to furthering the art, and are to be construed as being without limitation to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. An information processing apparatus which is connected to be able to communicate with a switching device connected to a first network and a second network to which a plurality of computers are connected, the information processing apparatus comprising:
a memory; and
a processor coupled with the memory and configured to
receive a notification of a security risk detected in one of the plurality of computers; and
when the notification is received, instruct the switching device to switch one of a connection destination network of the computer in which the security risk is detected and a connection destination network of a computer in which the security risk is not detected, to the first network and switch the other network to the second network.

2. The information processing apparatus according to claim 1, wherein a server that copes with the security risk in the computer is connected to the first network, and the processor is configured to execute a process of changing the connection destination network of the computer in which the security risk is detected, to the first network.

3. The information processing apparatus according to claim 1, wherein the processor is further configured to
manage an association relationship between a type of the security risk and a countermeasure of the security risk,
wherein when the notification is received, the processor is configured to execute a process of performing a countermeasure associated with the notified security risk.

4. The information processing apparatus according to claim 1, wherein when the notification is received, the processor is configured to execute a process of outputting a message of the detection of the security risk to a screen of the information processing apparatus.

5. The information processing apparatus according to claim 1, wherein the processor is further configured to
manage an association relationship between each of the plurality of computers and contact information of a user of each of the plurality of computers,
wherein when the notification is received, the processor is configured to execute a notification process to a user of the computer in which the security risk is detected.

6. The information processing apparatus according to claim 1, wherein when a notification is received indicating that the security risk has been eliminated from the computer in which the security risk was detected, the processor is configured to execute a process of instructing the switching device to switch a connection destination network of the computer from which the security risk has been eliminated, back to a network to which the computer was connected prior to the detection of the security risk.

7. The information processing apparatus according to claim 1, wherein each of the plurality of computers includes a physical server, the switching device includes a layer 2 switch (L2 switch) capable of changing a connection destination network of the physical server by a virtual local area network (VLAN), and the processor is configured to transfer an instruction to the L2 switch to change a setting of the VLAN such that one of a connection destination network of a physical server in which the security risk is detected and a connection destination network of a physical server in which the security risk is not detected is designated as the first network, and the other network is designated as the second network.

8. The information processing apparatus according to claim 1, wherein each of the plurality of computers includes a virtual server, the switching device includes a virtual server capable of changing a connection destination network of the virtual server by a virtual network, and the processor is configured to transfer an instruction to change a setting of the virtual network such that one of a connection destination network of a virtual server in which the security risk is detected and a connection destination network of a virtual server in which the security risk is not detected is designated as the first network, and the other network is designated as the second network.

9. A non-transitory computer-readable recording medium having stored therein a program for causing an information processing apparatus connected to be able to communicate with a switching device connected to a first network and a second network to which a plurality of computers are connected, to execute a process, the process comprising:
receiving a notification of a security risk detected in one of the plurality of computers; and
instructing, upon receiving the notification, the switching device to switch one of a connection destination network of the one of the plurality of computers in which the security risk is detected and a connection destination network of a computer in which the security risk is not detected, to the first network and switch the other network to the second network.

10. An information processing system, comprising:
a switching device connected to a first network and a second network to which a plurality of computers are connected;
an information processing apparatus connected to be able to communicate with the switching device; and
a server connected to the second network and capable of communicating with each of the plurality of computers and the information processing apparatus,
wherein the switching device includes a first hardware processor configured to switch a connection destination network of each of the plurality of computers between the first network and the second network,
the server includes a second hardware processor configured to, when a security risk is detected in one of the plurality of computers, transfer a notification including information specifying the computer in which the security risk is detected and information specifying the security risk, and
the information processing apparatus includes a third hardware processor configured to receive the notification from the server, and, when the notification is received from the server, Instruct the switching device to switch one of a connection destination network of the computer in which the security risk is detected and a connection destination network of a computer in which the security risk is not detected, to the first network and switch the other network to the second network.
